(19) United States
(12) Patent Application Publication
(10) Pub. No.: US 2026/0128819 A1
(43) Pub. Date: May 7, 2026

(54) UPLINK CONTROL CHANNEL REPETITIONS FOR FULL-DUPLEX SYSTEM

(71) Applicant: QUALCOMM Incorporated, San Diego, CA (US)

(72) Inventors: Muhammad Sayed Khairy ABDELGHAFFAR, San Jose, CA (US); Abdelrahman Mohamed IBRAHIM, San Diego, CA (US)

(21) Appl. No.: 19/381,880

(22) Filed: Nov. 6, 2025

Related U.S. Application Data
(60) Provisional application No. 63/717,432, filed on Nov. 7, 2024.

(51) Int. Cl. H04L 1/18; H04L 5/14

(52) U.S. Cl. CPC H04L 1/18; H04L 5/14

(57) ABSTRACT

Various aspects of the present disclosure generally relate to wireless communication. In some aspects, a network entity may receive first information indicating a pattern of one or more subband full-duplex (SBFD) time intervals and one or more non-SBFD time intervals. The network entity may receive second information associated with multiple repetitions of an uplink control channel communication, wherein the second information is indicative of a valid time interval type for the multiple repetitions, and wherein the valid time interval type is either an SBFD type or a non-SBFD type. The network entity may transmit one or more repetitions, of the multiple repetitions, during one or more time intervals having the valid time interval type. Numerous other aspects are described.

### CROSS-REFERENCE TO RELATED APPLICATION

This patent application claims priority to U.S. Provisional Patent Application No. 63/717,432, filed on Nov. 7, 2024, entitled “UPLINK CONTROL CHANNEL REPETITIONS FOR FULL-DUPLEX SYSTEM,” and assigned to the assignee hereof. The disclosure of prior Provisional Patent Application 63/717,432 is considered part of and is incorporated by reference into this patent application in its entirety.

### FIELD OF THE DISCLOSURE

Aspects of the present disclosure generally relate to wireless communication and specifically relate to techniques, apparatuses, and methods associated with uplink control channel repetitions for a full-duplex system.

### INTRODUCTION

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some aspects, a network entity includes a processing system configured to: receive first information indicating a pattern of one or more subband full-duplex (SBFD) time intervals and one or more non-SBFD time intervals: receive second information associated with multiple repetitions of an uplink control channel communication, wherein the second information is indicative of a valid time interval type for the multiple repetitions, and wherein the valid time interval type is either an SBFD type or a non-SBFD type; and transmit one or more repetitions, of the multiple repetitions, during one or more time intervals having the valid time interval type.

In some aspects, a network entity includes a processing system configured to: transmit first information indicating a pattern of one or more SBFD time intervals and one or more non-SBFD time intervals; transmit second information associated with multiple repetitions of an uplink control channel communication, wherein the second information is indicative of a valid time interval type for the multiple repetitions, and wherein the valid time interval type is either an SBFD type or a non-SBFD type; and receive one or more repetitions, of the multiple repetitions, during one or more time intervals having the valid time interval type.

In some aspects, a method of wireless communication performed by a network entity includes receiving first information indicating a pattern of one or more SBFD time intervals and one or more non-SBFD time intervals: receiving second information associated with multiple repetitions of an uplink control channel communication, wherein the second information is indicative of a valid time interval type for the multiple repetitions, and wherein the valid time interval type is either an SBFD type or a non-SBFD type; and transmitting one or more repetitions, of the multiple repetitions, during one or more time intervals having the valid time interval type.

In some aspects, a method of wireless communication performed by a network entity includes transmitting first information indicating a pattern of one or more SBFD time intervals and one or more non-SBFD time intervals: transmitting second information associated with multiple repetitions of an uplink control channel communication, wherein the second information is indicative of a valid time interval type for the multiple repetitions, and wherein the valid time interval type is either an SBFD type or a non-SBFD type; and receiving one or more repetitions, of the multiple repetitions, during one or more time intervals having the valid time interval type.

In some aspects, a non-transitory computer-readable medium has code stored thereon that, when executed by one or more processors of a network entity, causes the network entity to: receive first information indicating a pattern of one or more SBFD time intervals and one or more non-SBFD time intervals: receive second information associated with multiple repetitions of an uplink control channel communication, wherein the second information is indicative of a valid time interval type for the multiple repetitions, and wherein the valid time interval type is either an SBFD type or a non-SBFD type; and transmit one or more repetitions, of the multiple repetitions, during one or more time intervals having the valid time interval type.

In some aspects, a non-transitory computer-readable medium has code stored thereon that, when executed by one or more processors of a network entity, causes the network entity to: transmit first information indicating a pattern of one or more SBFD time intervals and one or more non-SBFD time intervals: transmit second information associated with multiple repetitions of an uplink control channel communication, wherein the second information is indicative of a valid time interval type for the multiple repetitions, and wherein the valid time interval type is either an SBFD type or a non-SBFD type; and receive one or more repetitions, of the multiple repetitions, during one or more time intervals having the valid time interval type.

In some aspects, an apparatus for wireless communication includes means for receiving first information indicating a pattern of one or more SBFD time intervals and one or more non-SBFD time intervals: means for receiving second information associated with multiple repetitions of an uplink control channel communication, wherein the second information is indicative of a valid time interval type for the multiple repetitions, and wherein the valid time interval type is either an SBFD type or a non-SBFD type; and means for transmitting one or more repetitions, of the multiple repetitions, during one or more time intervals having the valid time interval type.

In some aspects, an apparatus for wireless communication includes means for transmitting first information indicating a pattern of one or more SBFD time intervals and one or more non-SBFD time intervals: means for transmitting second information associated with multiple repetitions of an uplink control channel communication, wherein the second information is indicative of a valid time interval type for the multiple repetitions, and wherein the valid time interval type is either an SBFD type or a non-SBFD type; and means for receiving one or more repetitions, of the multiple repetitions, during one or more time intervals having the valid time interval type.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

The appended drawings illustrate certain example aspects of this disclosure and are therefore not limiting in scope. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram illustrating an example of a wireless communication network, in accordance with the present disclosure.

FIG. 3 is a diagram illustrating an example disaggregated network node architecture, in accordance with the present disclosure.

FIGS. 4A-4C are diagrams illustrating examples of full-duplex communication, in accordance with the present disclosure.

FIG. 5 is a diagram illustrating examples of full-duplex communication in a wireless network, in accordance with the present disclosure.

FIG. 6 is a diagram illustrating an example of an SBFD structure, in accordance with the present disclosure.

FIG. 7 is a diagram illustrating an example of a time domain resource allocation, in accordance with the present disclosure.

FIGS. 8-10 are diagrams of examples associated with uplink control channel repetitions for a full-duplex system, in accordance with the present disclosure.

FIG. 11 is a diagram illustrating an example process performed, for example, at a network entity or an apparatus of a network entity, in accordance with the present disclosure.

FIG. 12 is a diagram illustrating an example process performed, for example, at a network entity or an apparatus of a network entity, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. The scope of the disclosure covers any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure covers an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

“Full-duplex communication” in a wireless network refers to simultaneous bi-directional communication between devices in the wireless network. For example, a network entity (e.g., a user equipment (UE) or a network node) operating in a full-duplex mode may transmit a communication and receive a communication at the same time (e.g., in the same time interval). “Half-duplex communication” in a wireless network refers to unidirectional communications (e.g., only downlink communication, only uplink communication, or only sidelink communication) between network entities at a given time (e.g., in a given time interval). One type of full-duplex communication is subband full-duplex (SBFD) communication. In SBFD, a first network entity may transmit a communication to a second network entity and receive a communication from the second network entity (or a third network entity) at the same time, but on different frequency resources. For example, the different frequency resources may be subbands of a frequency band, such as a time division duplexing band. In such examples, the frequency resources used for downlink communication may be separated from the frequency resources used for uplink communication, in the frequency domain, by a guard band.

Although some aspects are described herein using a slot as an example time interval, the aspects and techniques described herein may be similarly applied to any time interval. The time interval may also be referred to as a time unit. For example, a time interval may include a frame, a subframe, a slot, a mini-slot (e.g., one or more symbols), a symbol (e.g., an OFDM symbol), a transmission time interval (TTI), a scheduling unit, and/or another time unit. For example, a slot (e.g., a downlink slot, an uplink slot, or an SBFD slot) used as an example herein may be a frame, a subframe, a mini-slot, one or more OFDM symbols, a TTI, and/or another time interval, in other examples in a similar manner as described herein. As used herein, “time interval” refers to a frame, a subframe, a slot, a mini-slot (e.g., one or more symbols), a single symbol (e.g., a single OFDM symbol), multiple symbols (e.g., multiple OFDM symbols), a TTI, a scheduling unit, and/or another time unit.

In some examples, a time division duplexing (TDD) configuration may configure a pattern (sometimes called a TDD pattern) of uplink time intervals, downlink time intervals, and/or flexible time intervals (sometime referred to as special time intervals) associated with a half-duplex mode. The slot format pattern may include a quantity of downlink time intervals, a quantity of flexible time intervals, and/or a quantity of uplink time intervals. The slot format pattern may repeat over time. In some examples, a network entity may be configured with an SBFD configuration that indicates one or more time intervals (e.g., indicated by the TDD pattern) that are to be SBFD time intervals. For example, the SBFD configuration may indicate that one or more downlink time intervals and/or one or more flexible time intervals are to be SBFD time intervals. The SBFD configuration may configure one or more downlink subbands and one or more uplink subbands (e.g., and one or more guard bands) for the one or more SBFD time intervals. Network entities that support SBFD communication may consider the one or more time intervals to be SBFD time intervals. Network entities that do not support SBFD communication may consider the one or more time intervals to be a type of time interval (e.g., downlink, flexible, or uplink) indicated by the TDD pattern.

Network entities that support SBFD communication (e.g., sometimes referred to as “SBFD aware” network entities) may be configured with a configuration that indicates whether transmissions and/or receptions across SBFD time intervals and non-SBFD time intervals (e.g., across SBFD symbols and non-SBFD symbols in different slots) are to be associated with a restriction as to a type of time interval in which the transmissions and/or receptions can occur. The transmissions and/or receptions across SBFD time intervals and non-SBFD time intervals may include periodic communications and/or repetitions of a communication that occur in different time intervals. A first configuration may indicate that the transmissions and/or receptions are restricted to SBFD time intervals only or non-SBFD time intervals only (e.g., only one type (e.g., SBFD or non-SBFD) of time interval is valid for the transmissions and/or receptions). A second configuration may indicate that the transmissions and/or receptions can occur in SBFD time intervals and non-SBFD time intervals (e.g., no restriction as to the valid type of time interval).

In some examples, a network entity may transmit one or more repetitions of a communication to improve coverage and/or reliability of the communication. As used herein, “repetition” may refer to an initial transmission of a message and also to a repeated transmission of the message. Thus, each transmission (regardless of whether the transmission is an initial transmission or a retransmission) may be referred to as a repetition. For example, a UE may transmit repetitions of an uplink control channel communication (e.g., a physical uplink control channel (PUCCH) communication). The uplink control channel communication may indicate feedback information (e.g., hybrid automatic repeat request (HARQ) feedback information), and/or a scheduling request, among other examples. A repetition factor can be indicated for a UE, which indicates a number of times that the UE should repeat transmission of the uplink control channel communication. The transmission of repetitions of the uplink control channel communication may improve robustness of the uplink control channel communication, which can experience poor performance in certain situations, such as when the UE is located at a cell edge or when uplink transmit power is limited.

The UE may determine one or more time intervals during which respective repetitions of an uplink control channel communication are to be transmitted. For example, the UE may determine the one or more time intervals by counting available time intervals from a reference time interval. For example, if a time interval is “counted” by the UE, then the UE may transmit a repetition of the control channel communication during the time interval. The reference time interval may be indicated by a slot offset in DCI (e.g., that triggers or schedules the uplink control channel communication), such as a K₁ value described in more detail elsewhere herein. As another example, the reference time interval may be indicated by configuration information (e.g., for periodic or semi-persistent uplink control channel communications). A time interval (e.g., an uplink time interval and/or a flexible time interval) may be counted by the UE if the uplink channel resource configured during the time interval does not overlap in the time domain with synchronization signal block (SSB) resources configured during the time interval and if the uplink channel resource configured during the time interval has enough consecutive uplink or flexible symbols for the uplink channel communication (e.g., as indicated by a nrofsymbols parameter indicated for the uplink channel communication).

The introduction of SBFD configurations may introduce ambiguity as to how network entities (e.g., UEs and/or network nodes) are to count and/or identify valid time intervals for repetitions of uplink channel communications. For example, as described above, a network entity may be configured with or without restrictions as to time interval types during which repetitions of uplink channel communications can be transmitted. How the network entities are to count time intervals for repetitions of uplink channel communications and/or what constitutes available time intervals for the purpose of counting is not defined for the different configurations. Further, in some examples, SBFD time intervals may include both SBFD symbols and non-SBFD symbols. In such examples, the network entities may not have a unified approach as to how and/or if such SBFD time intervals are to be counted for the purpose of determining time intervals during which repetitions of uplink channel communications are to be transmitted. Additionally, repetitions of uplink channel communications may be scheduled or configured to occur on a mini-slot (sometime referred to as a sub-slot) basis or inter-slot basis. In such examples, the network entities may not have a unified approach as to how and/or if SBFD time intervals are to be counted for the purpose of determining time intervals during which repetitions of uplink channel communications are to be transmitted (e.g., if the SBFD time intervals include both SBFD symbols and non-SBFD symbols). As a result, the network entities may not be synchronized as to which time intervals are to be used for transmissions of repetitions of a given uplink channel communication. This may result in degraded performance, missed repetitions, and/or consumption of network resources associated with the transmission of the given uplink channel communication.

Various aspects relate generally to control channel repetitions (e.g., uplink control channel repetitions) for a full-duplex system. Some aspects more specifically relate to valid time interval determinations and/or counting determinations for uplink control channel repetitions in an SBFD system. For example, a first network entity may transmit, and a second network entity may receive, first information indicating a pattern of one or more SBFD time intervals and one or more non-SBFD time intervals. The first network entity may transmit, and the second network entity may receive, second information associated with multiple repetitions of an uplink control channel communication. The second information may be indicative of a valid time interval type (e.g., an SBFD type or a non-SBFD type) for the multiple repetitions. For example, the second information may indicate a reference time interval for the uplink control channel communication and the valid time interval type may be based on a time interval type of the reference time interval. As another example, the second information may include an uplink channel resource configuration (e.g., a PUCCH resource configuration, a PUCCH resource set configuration, and/or a PUCCH configuration) for one or more uplink channel resources (e.g., PUCCH resources) to be used to transmit the multiple repetitions. The uplink channel resource configuration may indicate the valid time interval type.

The second network entity may transmit, and the first network entity may receive, one or more repetitions, of the multiple repetitions, during one or more time intervals having the valid time interval type. For example, the second network entity may count a time interval (e.g., indicated by the first information) as available for the purposes of uplink channel communication repetition transmission if the time interval has the valid time interval type.

Particular aspects of the subject matter described in this disclosure can be implemented to realize one or more of the following potential advantages. In some examples, the described techniques can be used to synchronize which time intervals are available and/or valid for uplink channel communication repetition transmission between network entities. This may improve the performance and/or reliability of uplink channel communication repetition transmissions. For example, this may reduce the likelihood of a first network entity attempting to receive a repetition during a time interval which was determined to be invalid and/or unavailable for the transmission of the repetition by the second network entity. By the first network entity and the second network entity using an indicated valid time interval type, the first network entity and the second network entity may determine which time intervals are to be counted for repetitions of an uplink channel communication in a unified manner when SBFD time intervals are configured. In some aspects, by the first network entity and the second network entity using the time interval type indicated by a reference time interval as the valid time interval type, the first network entity and the second network entity may determine the time interval type in a flexible manner (e.g., the valid time interval type may change over time, depending on the time interval type of a reference time interval for a given uplink control channel communication). In some aspects, the first network entity and the second network entity using a valid time interval type indicated by an uplink channel resource configuration may improve the likelihood of the first network entity and the second network entity being synchronized as to the valid time interval type because the valid time interval type may not change frequently over time.

Various aspects of the disclosure are described more fully hereinafter with reference to the accompanying drawings. This disclosure may, however, be embodied in many different forms and is not limited to any specific structure, function, example, aspect, or the like presented throughout this disclosure. This disclosure includes, for example, any aspect disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, network entity, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

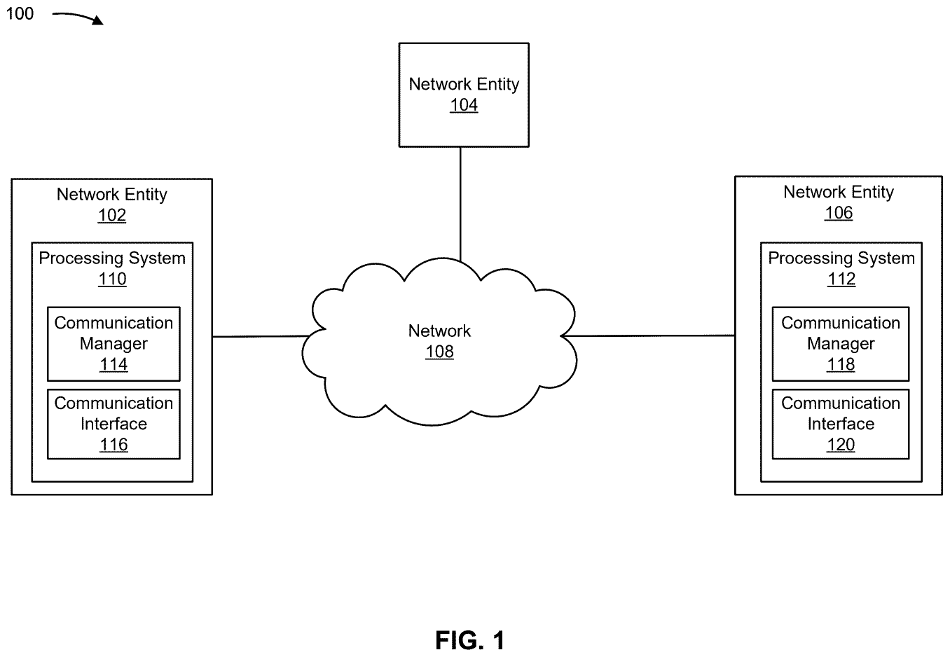

FIG. 1 is a diagram illustrating an example environment 100 in which apparatuses and/or methods described herein may be implemented, in accordance with the present disclosure. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary and/or mobile. The network 108 may include wired communication connections, wireless communication connections, or a combination of wired and wireless communication connections.

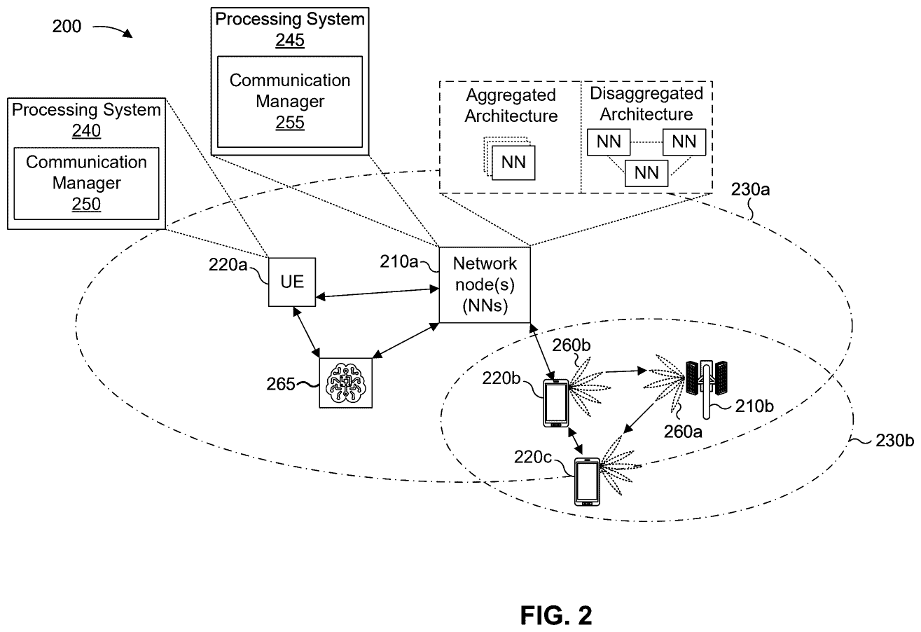

The network 108 may include, for example, a cellular network (e.g., a Long-Term Evolution (LTE) network, a CDMA network, a 4G network, a 5G network, a 6G network, or another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity.” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 and/or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 and/or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, and/or a transceiver, among other examples. For example, a communication interface may include one or more transceivers, one or more receivers, and/or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, and/or a modulation component, among other examples.

A communication interface may include a transmission component and/or a reception component. For example, a communication interface may include a transceiver and/or one or more separate receivers and/or transmitters that enable a network entity to communicate with other devices, such as via a wired connection, a wireless connection, or a combination of wired and wireless connections. In some examples, a communication interface may include one or more radio frequency reflective elements and/or one or more radio frequency refractive elements. The communication interface may enable the network entity to receive information from another apparatus and/or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

As described herein, a network entity (e.g., the network entity 102 and/or the network entity 106) may be configured to perform one or more operations. Reference to a network entity being configured to perform one or more operations may refer to a processing system of the network entity being configured to perform the one or more operations and/or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, and/or at least one communication interface, among other examples, that are configured to perform one or more (or all) of the one or more operations, and/or any combination thereof. Where reference is made to the network entity and/or the processing system being configured to perform operations, the network entity and/or the processing system may be configured to cause one component to perform all operations, or to cause more than one component to collectively perform the operations. When the network entity and/or the processing system is configured to cause more than one component to collectively perform the operations, each operation need not be performed by each of those components (e.g., different operations may be performed by different components) and/or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 and/or the communication interface 116 to) receive first information indicating a pattern of one or more SBFD time intervals and one or more non-SBFD time intervals: receive second information associated with multiple repetitions of an uplink control channel communication, wherein the second information is indicative of a valid time interval type for the multiple repetitions, and wherein the valid time interval type is either an SBFD type or a non-SBFD type; and/or transmit one or more repetitions, of the multiple repetitions, during one or more time intervals having the valid time interval type. Additionally, or alternatively, the network entity 102 and/or the communication manager 114 may perform one or more other operations described herein.

As described in more detail elsewhere herein, the network entity 106 may (e.g., the processing system 112 may, or the processing system 112 may cause the communication manager 114 and/or the communication interface 116 to) transmit first information indicating a pattern of one or more SBFD time intervals and one or more non-SBFD time intervals: transmit second information associated with multiple repetitions of an uplink control channel communication, wherein the second information is indicative of a valid time interval type for the multiple repetitions, and wherein the valid time interval type is either an SBFD type or a non-SBFD type; and/or receive one or more repetitions, of the multiple repetitions, during one or more time intervals having the valid time interval type. Additionally, or alternatively, the network entity 106 and/or the communication manager 118 may perform one or more other operations described herein.

The number and arrangement of entities shown in FIG. 1 are provided as one or more examples. In practice, there may be additional network entities and/or networks, fewer network entities and/or networks, different network entities and/or networks, or differently arranged network entities and/or networks than those shown in FIG. 1. Furthermore, the network entity 102, 104, and 106 may be implemented using a single apparatus or multiple apparatuses.

FIG. 2 is a diagram illustrating an example of a wireless communication network 200, in accordance with the present disclosure. The wireless communication network 200 may be or may include elements of a 5G (or NR) network or a 6G network, among other examples. The wireless communication network 200 may include multiple network nodes 210. For example, in FIG. 2, the wireless communication network 200 includes a network node (NN) 210a and a network node 210b. The network nodes 210 may support communications with multiple UEs 220. For example, in FIG. 2, the network nodes 210 support communication with a UE 220a, a UE 220b, and a UE 220c. In some examples, a UE 220 may also communicate with other UEs 220 and a network node 210 may communicate with a core network and with other network nodes 210.

The network nodes 210 and the UEs 220 of the wireless communication network 200 may communicate using the electromagnetic spectrum, which may be subdivided by frequency or wavelength into various classes, bands, carriers, and/or channels. For example, devices of the wireless communication network 200 may communicate using one or more operating bands.

In some aspects, multiple wireless communication networks 200 may be deployed in a given geographic area. Each wireless communication network 200 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 200 may implement dynamic spectrum sharing (DSS), in which multiple RATs are implemented with dynamic bandwidth allocation (for example, based on user demand) in a single frequency band. In some examples, the wireless communication network 200 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHZ, that are within FR1, and/or that are included in mid-band frequencies. Similarly, the term “millimeter wave.” if used herein, may broadly refer to mid-band frequencies or to frequencies that are within FR2, FR4, FR4-a or FR4-1. FR5, and/or the EHF band. Higher frequency bands may extend 5G NR operation, 6G operation, and/or other RATs beyond 52.6 GHz.

A network node 210 and/or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system, such as a processing system 240 of the UE 220 or a processing system 245 of the network node 210. The processing system 240 and the processing system 245 may be similar to other processing systems described herein, such as the processing system 110 and the processing system 112. A processing system (for example, the processing system 240 and/or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry.”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry.”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 and/or the processing system 245 include or implement one or more of the modems. The processing system 240 and the processing system 245 may also include or be coupled with multiple radios (collectively “the radio”), multiple RF chains, or multiple transceivers, each of which may in turn be coupled with one or more of multiple antennas. In some examples, one or more processors of the processing system 240 and/or the processing system 245 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 240 of the UE 220 or by the processing system 245 of the network node 210).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 210 and the UE 220.

A network node 210 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may consist of a single standalone base station or a single TRP that operates with a full radio protocol stack to enable or facilitate communication between a UE 220 and a core network of the wireless communication network 200.

Alternatively, and as also shown, a network node 210 may be a disaggregated network node (sometimes referred to as a disaggregated base station), having a disaggregated architecture, meaning that the network node 210 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 210 (for example, a base station, an RU, or a TRP) may provide communication coverage for a particular geographic area. The term “cell” can refer to a coverage area of a network node 210 or to a network node 210 itself, depending on the context in which the term is used. A network node 210 may support one or more cells (for example, each cell may support communication within an angular (for example, 60 degree) range around the network node). In some examples, a network node 210 may provide communication coverage for a macro cell, a pico cell, a femto cell, or another type of cell. A macro cell may cover a relatively large geographic area (for example, several kilometers in radius) and may allow unrestricted access by UEs 220 with associated service subscriptions. A pico cell may cover a relatively small geographic area and may also allow unrestricted access by UEs 220 with associated service subscriptions. A femto cell may cover a relatively small geographic area (for example, a home) and may allow restricted access by UEs 220 having association with the femto cell (for example, UEs 220 in a closed subscriber group (CSG)). In some examples, a cell may not necessarily be stationary. For example, the geographic area of the cell may move according to the location of an associated mobile network node 210 (for example, a train, a satellite, an unmanned aerial vehicle, or an NTN network node).

The wireless communication network 200 may be a heterogeneous network that includes network nodes 210 of different types, such as macro network nodes, pico network nodes, femto network nodes, relay network nodes, aggregated network nodes, and/or disaggregated network nodes, among other examples. Various different types of network nodes 210 may generally transmit at different power levels, serve different coverage areas (for example, a cell 230a and a cell 230b), and/or have different impacts on interference in the wireless communication network 200 than other types of network nodes 210.

The UEs 220 may be physically dispersed throughout the coverage area of the wireless communication network 200, and each UE 220 may be stationary or mobile. A UE 220 may be, may include, or may also be referred to as an access terminal, a mobile station, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 220 may be classified according to different categories in association with different complexities and/or different capabilities. UEs 220 in a first category may facilitate massive IoT in the wireless communication network 200, and may offer low complexity and/or cost relative to UEs 220 in a second category. UEs 220 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 200, among other examples. A third category of UEs 220 may have mid-tier complexity and/or capability (for example, a capability between that of the UEs 220 of the first category and that of the UEs 220 of the second capability). A UE 220 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) and/or reconfigured (for example, in real-time or near-real-time) according to changing network conditions in the wireless communication network 200 and/or specific requirements of one or more UEs 220. An active BWP defines the operating bandwidth of the UE 220 within the operating bandwidth of the serving cell. The use of BWPs enables more efficient use of the available frequency domain resources in the wireless communication network 200 because fewer frequency domain resources may be allocated to a BWP for a UE 220 (which may reduce the quantity of frequency domain resources that a UE 220 is required to monitor and reduce UE power consumption by enabling the UE to monitor fewer frequency domain resources), leaving more frequency domain resources to be spread across multiple UEs 220. Thus, BWPs may also assist in the implementation of lower-capability (for example. RedCap) UEs 220 by facilitating the configuration of smaller bandwidths for communication by such UEs 220 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR). HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM. 128-QAM, or 256-QAM, among other examples) for a downlink signal or an uplink signal. For example, the network node 210 may select an MCS for a downlink signal in accordance with UCI received from the UE 220. The network node 210 may transmit, to the UE 220, an indication of the selected MCS for the downlink signal, such as via DCI that schedules the downlink signal. As another example, the network node 210 may transmit, and the UE 220 may receive, an indication of an MCS to be applied for the one or more uplink signals, such as via DCI scheduling transmission of the one or more uplink signals.

The network node 210 or the UE 220 (such as by using the processing system 245 or the processing system 240, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 210 or the UE 220 (for example, using the processing system 245 or the processing system 240, respectively, and/or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 and/or one or more modems) may further perform spatial processing (for example, precoding) on the encoded information to generate one or more processed or precoded signals for downlink or uplink transmission, respectively. In some examples, the network node 210 or the UE 220 may perform codebook-based precoding or non-codebook-based precoding. Codebook-based precoding may involve selecting a precoder (for example, a precoding matrix) using a codebook. For example, the network node 210 may provide precoding information indicating which precoder, defined by the codebook, is to be used by the UE 220. Non-codebook-based precoding may involve selecting or deriving a precoder based on, or otherwise associated with, one or more downlink or uplink signal measurements. The network node 210 or the UE 220 may transmit the processed downlink or uplink signals, respectively, via one or more antennas.

The network node 210 or the UE 220 may receive uplink signals or downlink signals, respectively, via one or more antennas. The network node 210 or the UE 220 (for example, using the processing system 245 or the processing system 240, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 210 or the UE 220 via the downlink or uplink signals. The network node 210 or the UE 220 (for example, using the processing system 245 or the processing system 240, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 220 and a network node 210 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 210 and/or UE 220 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 210b may generate one or more beams 260a, and the UE 220b may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 210 and/or at the UE 220, such as in a network implementing mmWave technology. Massive MIMO may improve communication reliability by enabling a network node 210 and/or a UE 220 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 210 and the UE 220 may perform one or more beam management operations, such as an initial beam acquisition operation, one or more beam refinement operations, and/or a beam recovery operation. For example, an initial beam acquisition operation may involve the network node 210 transmitting signals (for example, SSBs, CSI-RSs, or other signals) via respective beams (for example, of the beams 260a of the network node 210) and the UE 220 receiving and measuring the signal(s) via respective beams of multiple beams (for example, from the beams 260b of the UE 220) to identify a best beam (or beam pair) for communication between the UE 220 and the network node 210. For example, the UE 220 may transmit an indication (for example, in a message associated with a random access channel (RACH) operation) of a (best) identified beam of the network node 210 (for example, by indicating an SSBRI or other identifier associated with the beam). A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 210 and the UE 220 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 265 (for example, a network node 210 and/or UEs 220). For example, the one or more devices 265 may include a UE 220 (for example, the processing system 240), a network node 210 (for example, the processing system 245), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 220 and a second portion of the AI/ML model may be deployed at a network node 210). In other examples, a first AI/ML model may be deployed at a UE 220 and a second AI/ML model may be deployed at a network node 210. The AI/ML model(s) may be configured to enhance various aspects of the wireless communication network 200. For example, the AI/ML model(s) may be trained to identify patterns or relationships in data corresponding to the wireless communication network 200, a device, and/or an air interface, among other examples. The AI/ML model(s) may support operational decisions relating to one or more aspects associated with wireless communications devices, networks, or services.

In some aspects, a first network entity (e.g., a UE 220) may include a communication manager 250. As described in more detail elsewhere herein, the communication manager 250 may receive first information indicating a pattern of one or more SBFD time intervals and one or more non-SBFD time intervals: receive second information associated with multiple repetitions of an uplink control channel communication, wherein the second information is indicative of a valid time interval type for the multiple repetitions, and wherein the valid time interval type is either an SBFD type or a non-SBFD type; and/or transmit one or more repetitions, of the multiple repetitions, during one or more time intervals having the valid time interval type. Additionally, or alternatively, the communication manager 250 may perform one or more other operations described herein.

In some aspects, a first network entity (e.g., a network node 210) may include a communication manager 255. As described in more detail elsewhere herein, the communication manager 255 may transmit first information indicating a pattern of one or more SBFD time intervals and one or more non-SBFD time intervals: transmit second information associated with multiple repetitions of an uplink control channel communication, wherein the second information is indicative of a valid time interval type for the multiple repetitions, and wherein the valid time interval type is either an SBFD type or a non-SBFD type; and/or receive one or more repetitions, of the multiple repetitions, during one or more time intervals having the valid time interval type. Additionally, or alternatively, the communication manager 250 may perform one or more other operations described herein.

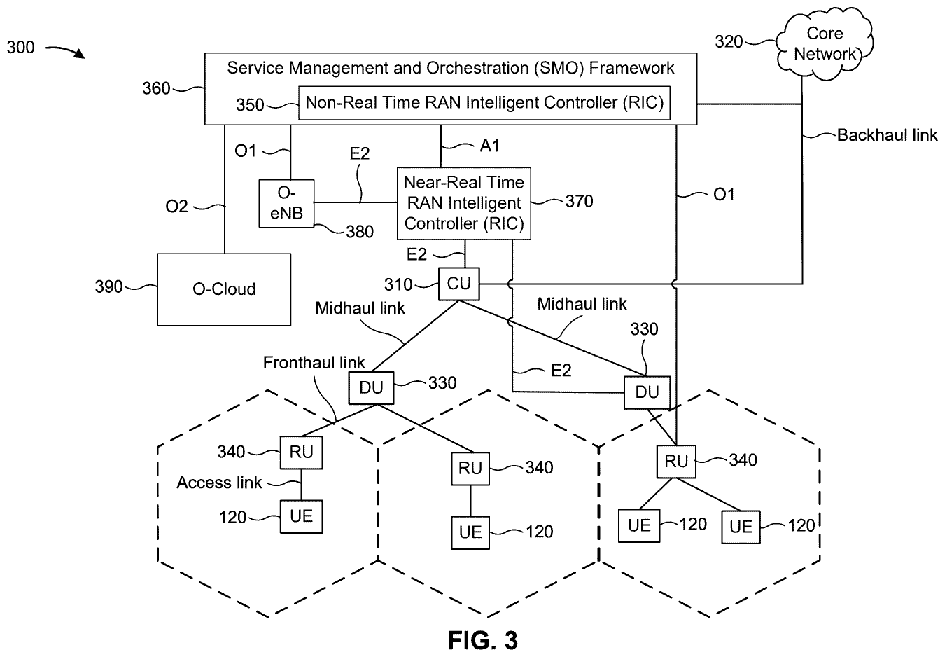

FIG. 3 is a diagram illustrating an example disaggregated network node architecture 300, in accordance with the present disclosure. One or more components of the example disaggregated network node architecture 300 may be, may include, or may be included in one or more network nodes (such one or more network nodes 210). The disaggregated network node architecture 300 may include a CU 310 that can communicate directly with a core network 320 via a backhaul link, or that can communicate indirectly with the core network 320 via one or more disaggregated control units, such as a non-real-time (Non-RT) RAN intelligent controller (RIC) 350 associated with a Service Management and Orchestration (SMO) Framework 360 and/or a near-real-time (Near-RT) RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 220 via respective RF access links. In some deployments, a UE 220 may be simultaneously served by multiple RUs 340.

Each of the components of the disaggregated network node architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB 380 with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

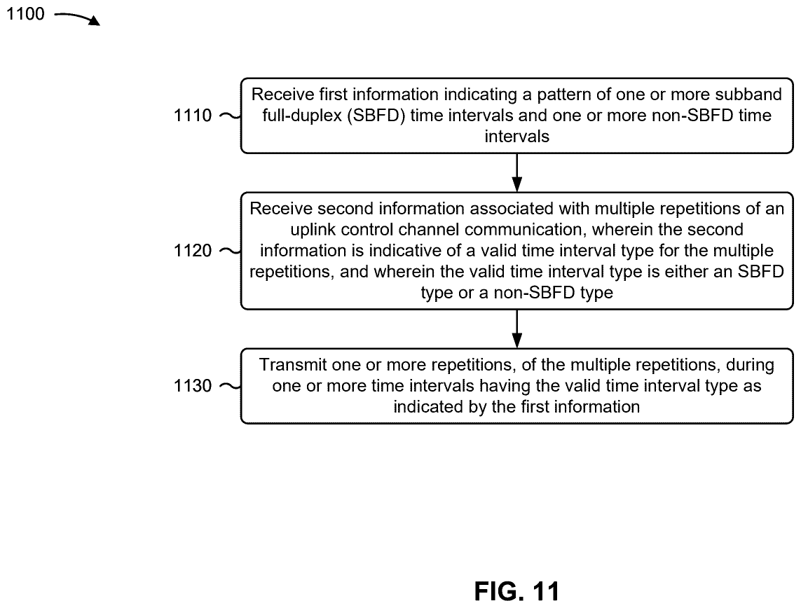

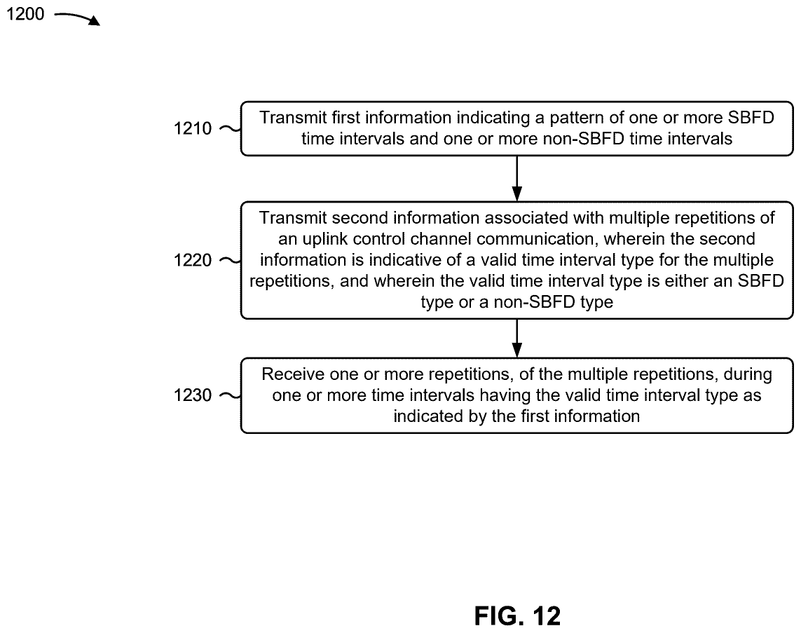

The network entity 102, the processing system 110 of the network entity 102, the network entity 106, the processing system 112 of the network entity 106, the network node 210, the processing system 245 of the network node 210, the UE 220, the processing system 240 of the UE 220, the CU 310, the DU 330, the RU 340, or any other component(s) of FIGS. 1-3 may implement one or more techniques or perform one or more operations associated with uplink control channel repetitions in an SBFD system, as described in more detail elsewhere herein. For example, the processing system 110 of the network entity 102, the processing system 112 of the network entity 106, the processing system 245 of the network node 210, the processing system 240 of the UE 220, the CU 310, the DU 330, or the RU 340 may perform or direct operations of, for example, process 1100 of FIG. 11, process 1200 of FIG. 12, or other processes as described herein (alone or in conjunction with one or more other processors). Memory of the network node 210 may store data and program code (or instructions) for the network node 210, the CU 310, the DU 330, or the RU 340. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, the UE 220, the CU 310, the DU 330, or the RU 340, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

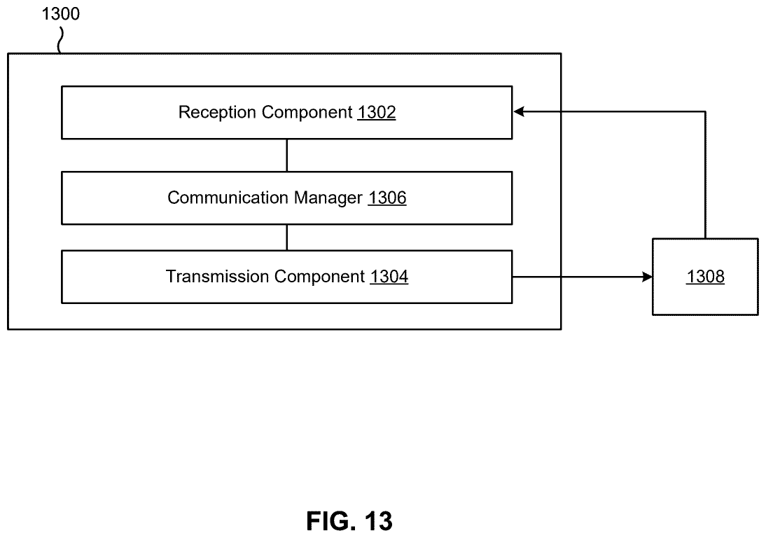

In some aspects, a first network entity includes means for receiving first information indicating a pattern of one or more SBFD time intervals and one or more non-SBFD time intervals: means for receiving second information associated with multiple repetitions of an uplink control channel communication, wherein the second information is indicative of a valid time interval type for the multiple repetitions, and wherein the valid time interval type is either an SBFD type or a non-SBFD type; and/or means for transmitting one or more repetitions, of the multiple repetitions, during one or more time intervals having the valid time interval type. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1302 depicted and described in connection with FIG. 13) and/or a transmission component (for example, transmission component 1304 depicted and described in connection with FIG. 13), among other examples.

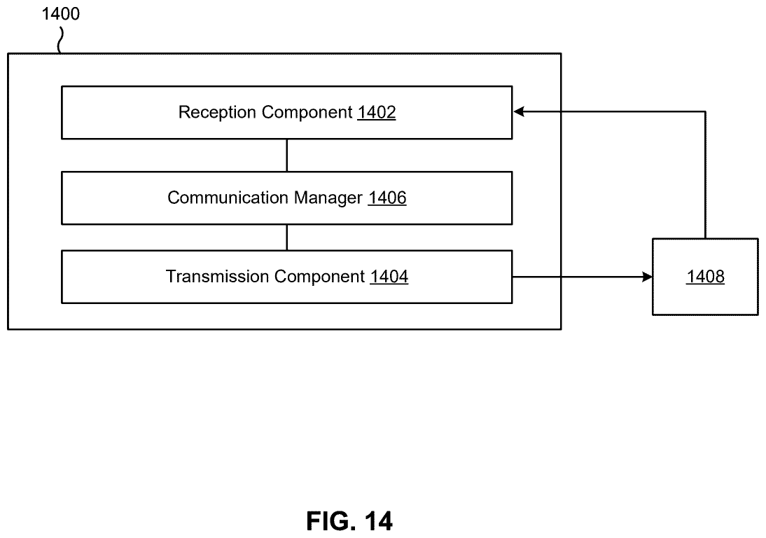

In some aspects, a first network entity includes means for transmitting first information indicating a pattern of one or more SBFD time intervals and one or more non-SBFD time intervals: means for transmitting second information associated with multiple repetitions of an uplink control channel communication, wherein the second information is indicative of a valid time interval type for the multiple repetitions, and wherein the valid time interval type is either an SBFD type or a non-SBFD type; and/or means for receiving one or more repetitions, of the multiple repetitions, during one or more time intervals having the valid time interval type. In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

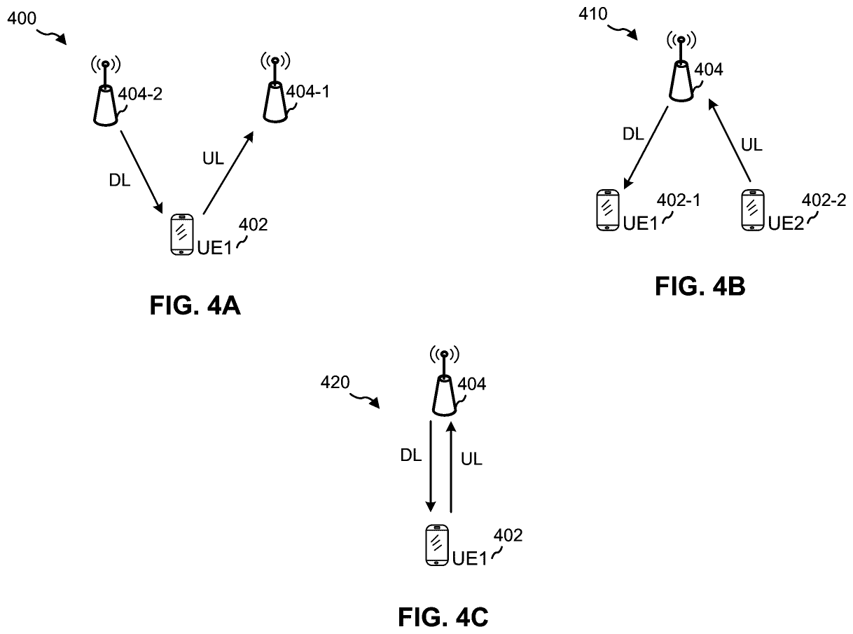

FIGS. 4A-4C are diagrams illustrating examples 400, 410, 420 of full-duplex communication, in accordance with the present disclosure. The example 400 of FIG. 4A includes a UE1 402 and two network nodes (e.g., TRPs) 404-1, 404-2, where the UE1 402 is sending uplink transmissions to network node 404-1 and is receiving downlink transmissions from base station 404-2. In the example 400 of FIG. 4A, full-duplex operation is enabled for the UE1 402, but not for the network node 404-1 and network node 404-2. The example 410 of FIG. 4B includes two UEs, shown as UE1 402-1 and UE2 402-2, and a network node 404, where the UE1 402-1 is receiving a downlink transmission from the network node 404 and the UE2 402-2 is transmitting an uplink transmission to the network node 404. In the example 410 of FIG. 4B, full-duplex operation is enabled for the network node 404, but not for UE1 402-1 and UE2 402-2. The example 420 of FIG. 4C includes a UE1 402 and a network node 404, where the UE1 402 is receiving a downlink transmission from the network node 404 and the UE1 402 is transmitting an uplink transmission to the network node 404. In the example 420 of FIG. 4C, full-duplex operation is enabled for both the UE1 402 and the network node 404.

As indicated above, FIGS. 4A-4C are provided as one or more examples. Other examples may differ from what is described with regard to FIGS. 4A-4C.

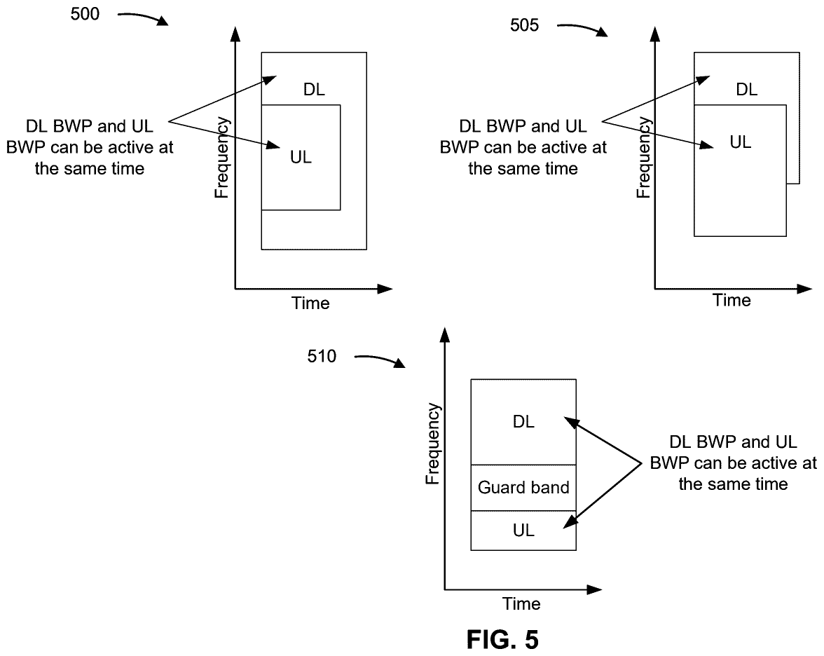

FIG. 5 is a diagram illustrating examples 500, 505, and 510 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 5, examples 500 and 505 show examples of in-band full-duplex (IBFD) communication. In IBFD, a UE may transmit an uplink communication to a base station and receive a downlink communication from the base station on the same time and frequency resources. As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

As further shown in FIG. 5, example 510 shows an example of SBFD communication, which may also be referred to as “subband frequency division duplex (SBFDD)” or “flexible duplex.” In SBFD, a first network entity may transmit a communication to a second network entity and receive a communication from the second network entity (or a third network entity) at the same time, but on different frequency resources. For example, the different frequency resources may be subbands of a frequency band, such as a time division duplexing band. In this case, the frequency resources used for downlink communication may be separated from the frequency resources used for uplink communication, in the frequency domain, by a guard band.

As indicated above, FIG. 5 is provided as an example. Other examples may differ from what is described with respect to FIG. 5.

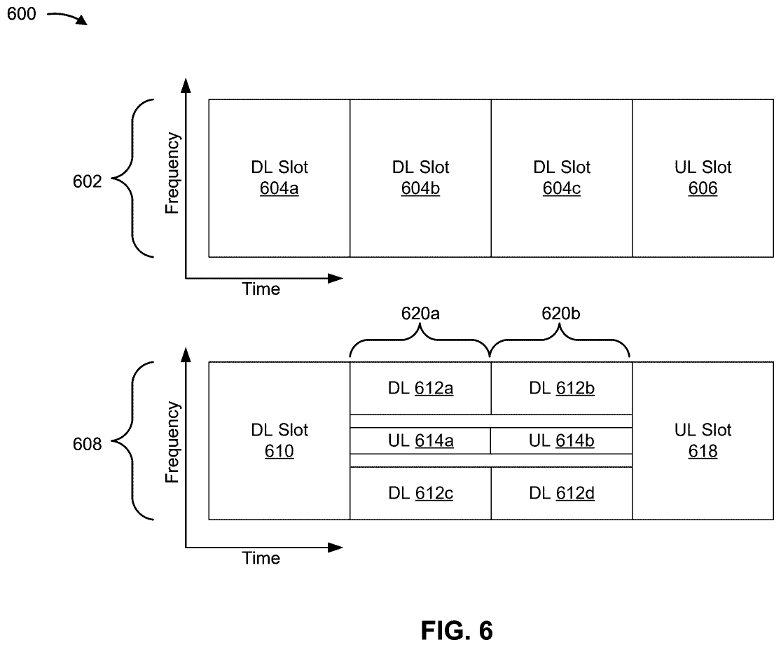

FIG. 6 is a diagram illustrating an example 600 of an SBFD structure, in accordance with the present disclosure. As shown in FIG. 6, example 600 includes a first slot structure 602. In some aspects, the first slot structure 602 may indicate a first slot format pattern (sometimes called a TDD pattern) associated with a half-duplex mode or a full-duplex mode. The first slot format pattern may include a quantity of downlink slots (e.g., three downlink slots 604a, 604b, and 604c, as shown in FIG. 6), a quantity of flexible slots (not shown), and/or a quantity of uplink slots (e.g., one uplink slot 606, as shown in FIG. 6). The first slot format pattern may repeat over time. In some aspects, a network node 210 may indicate the first slot format pattern to a UE 220 using one or more slot format indicators. A slot format indicator, for a slot, may indicate whether that slot is an uplink slot, a downlink slot, or a flexible slot, among other examples.

Although some aspects are described herein using a slot as an example time interval, the aspects and techniques described herein may be similarly applied to any time interval. The time interval may also be referred to as a time unit. For example, a time interval may include a frame, a subframe, a slot, a mini-slot (e.g., one or more symbols), a symbol (e.g., an OFDM symbol), a transmission time interval (TTI), a scheduling unit, and/or another time unit. For example, a slot (e.g., a downlink slot, an uplink slot, or an SBFD slot) may be a frame, a subframe, a mini-slot, one or more OFDM symbols, a TTI, and/or another time interval, in other examples. As used herein, “time interval” refers to a frame, a subframe, a slot, a mini-slot (e.g., one or more symbols), a symbol (e.g., an OFDM symbol), a TTI, a scheduling unit, and/or another time unit.

The network node 210 may configure a UE 220 with a second slot structure 608. In some examples, the network node 210 may transmit an indication for the UE 220 to switch from using the first slot structure 602 to using the second slot structure 608. As an alternative, the UE 220 may indicate to the network node 210 that the UE 220 is switching from using the first slot structure 602 to using the second slot structure 608. The second slot structure 608 may indicate a second slot format pattern that repeats over time, similar to the first slot format pattern. In any of the examples described above, the UE 220 may switch from the first slot structure 602 to the second slot structure 608 during a time period (e.g., a quantity of symbols and/or an amount of time (e.g., in ms)) based at least in part on an indication received from the network node 210 (e.g., before switching back to the first slot structure 602). During that time period, the UE 220 may communicate using the second slot format pattern, and then may revert to using the first slot format pattern after the end of the time period. The time period may be indicated by the network node 210 (e.g., in the instruction to switch from the first slot structure 602 to the second slot structure 608, as described above) and/or based at least in part on a programmed and/or otherwise preconfigured rule. For example, the rule may be based at least in part on a table (e.g., defined in 3GPP specifications and/or another wireless communication standard) that associates different SCSs and/or numerologies (e.g., represented by u and associated with corresponding SCSs) with corresponding time periods for switching configurations.

In example 600, the second slot structure 608 includes two SBFD slots 620 (shown as SBFD slot 620a and SBFD slot 620b) in place of what were downlink slots in the first slot format pattern. In example 600, each SBFD slot includes a partial slot (e.g., a portion or subband of a frequency allocated for use by the network node 210 and the UE 220) for downlink (e.g., partial slots 612a, 612b, 612c, and 612d, as shown) and a partial slot for uplink (e.g., partial slots 614a and 614b, as shown). A partial downlink slot 612 may be referred to as a downlink subband within an SBFD time interval (e.g., an SBFD slot or an SBFD symbol). A partial uplink slot 614 may be referred to as an uplink subband within an SBFD time interval (e.g., an SBFD slot or an SBFD symbol). Accordingly, the UE 220 may operate using the second slot format pattern to transmit an uplink communication in an earlier slot (e.g., the second slot in sequence, shown as partial uplink slot 614a) as compared to using the first slot format pattern (e.g., the fourth slot in sequence, shown as uplink slot 606). Other examples may include additional or alternative changes. For example, the second slot structure 608 may indicate an SBFD slot in place of what was an uplink slot in the first slot structure 602 (e.g., UL slot 606). In another example, the second slot structure 608 may indicate a downlink slot or an uplink slot in place of what was an SBFD slot in the first slot structure 602 (not shown in FIG. 6). In yet another example, the second slot structure 608 may indicate a downlink slot or an uplink slot in place of what was an uplink slot or a downlink slot, respectively, in the first slot structure 602. As shown in FIG. 6, the second slot structure 608 includes a downlink slot 610 and an uplink slot 618.

An “SBFD time interval” may refer to a time interval (e.g., a slot, a mini-slot, a subframe, an OFDM symbol, a transmission time interval, or another time interval) in which an SBFD format is used. An SBFD format may include a slot format in which full-duplex communication is supported (e.g., for both uplink and downlink communications), with one or more frequencies used for an uplink portion (e.g., an uplink subband) of the slot being separated from one or more frequencies used for a downlink portion (e.g., a downlink subband) of the slot by a guard band. A “portion” of a slot may refer to a portion of frequency resources, such as a subband. For example, an uplink portion may refer to a portion of frequency resources configured for uplink operation within the slot. In some examples, the SBFD format may include a single uplink portion and a single downlink portion separated by a guard band. In some examples, the SBFD format may include multiple downlink portions and a single uplink portion that is separated from the multiple downlink portions by respective guard bands (e.g., as shown in FIG. 6). In some examples, an SBFD format may include multiple uplink portions and a single downlink portion that is separated from the multiple uplink portions by respective guard bands. In some examples, the SBFD format may include multiple uplink portions and multiple downlink portions, where each uplink portion is separated from a downlink portion by a guard band. In some examples, operating using an SBFD mode may include activating or using a full-duplex mode in one or more slots based at least in part on the one or more slots having the SBFD format. A slot may support the SBFD mode if an uplink BWP and a downlink BWP are permitted to be or are simultaneously active in the slot in an SBFD fashion (e.g., with guard band separation).

By using the second slot structure 608, the network node 210 and the UE 220 may experience increased quality and/or reliability of communications. For example, the network node 210 and the UE 220 may experience increased throughput (e.g., using a full-duplex mode), reduced latency (e.g., the UE 220 may be able to transmit an uplink and/or a downlink communication sooner using the second slot structure 608 rather than the first slot structure 602), and increased network resource utilization (e.g., by using both a downlink BWP and an uplink BWP simultaneously instead of only the downlink BWP or the uplink BWP).

In some examples, a UE 220 may support SBFD operation. In such examples, the UE 220 may be configured to use the second slot structure 608 for increased throughput and/or reduced latency for uplink communications. In other examples, a UE 220 may not support SBFD operation. In such examples, the network node 210 may refrain from configuring the UE 220 to use the second slot structure 608. Additionally, or alternatively, if the network node 210 configures the second slot structure, then a UE 220 that does not support SBFD operation may consider or identify SBFD slots (e.g., the SBFD slot 620a or the SBFD slot 620b) as downlink slots. This enables the UE 220 that does not support SBFD operation to receive downlink communications in a downlink portion of the SBFD slots without attempting to perform an SBFD operation that is not supported by the UE 220.

As indicated above, FIG. 6 is provided as an example. Other examples may differ from what is described with respect to FIG. 6.

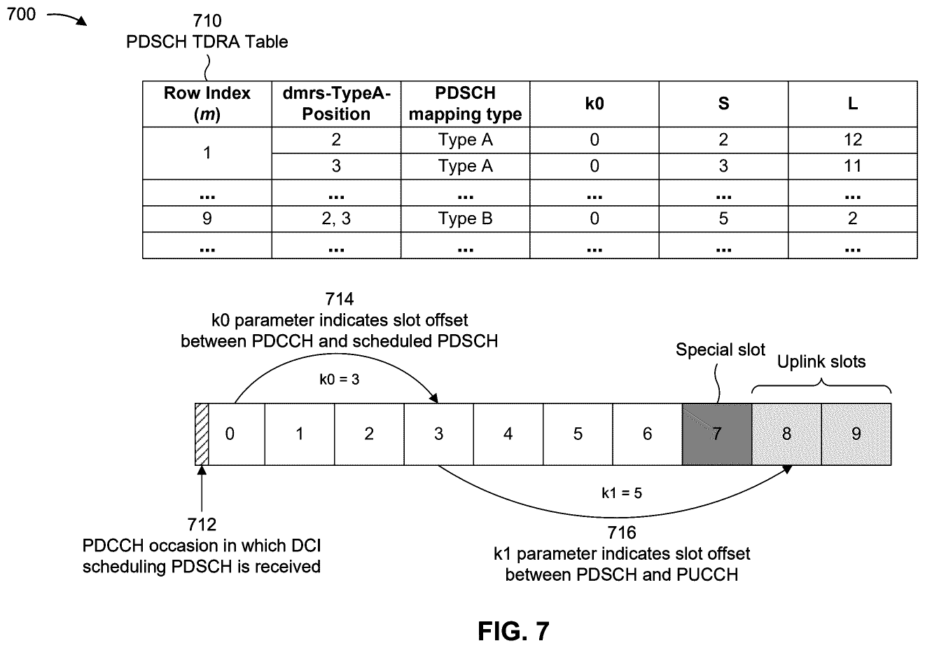

FIG. 7 is a diagram illustrating an example 700 of a time domain resource allocation (TDRA), in accordance with the present disclosure. FIG. 7 shows an example downlink TDRA table 710. The downlink TDRA table 710 may be, for example, a PDSCH TDRA table. In some examples, a network node 210 and the UE 220 may use different TDRA tables than shown in FIG. 7, such as for different configurations, different cells, and/or different sub-carrier spacings of cells.

When scheduling a downlink communication or an uplink communication, a network node 210 may transmit a PDCCH transmission carrying DCI that indicates a TDRA for the downlink or uplink communication. For example, the DCI may include a TDRA field that includes a TDRA index value. The TDRA index value may indicate a row index of a corresponding TDRA table, and the row index may correspond to a set of TDRA parameters (sometimes referred to as scheduling parameters or scheduling information). The network node 210 and the UE 220 may use the TDRA parameters in the corresponding row index for the downlink or uplink communication scheduled via the DCI. In the example shown in FIG. 7, a TDRA index value of m in the DCI may correspond to a row index of m+1 in the TDRA table. For example, a TDRA index value of 0 may correspond to a row index of 1.

As shown in FIG. 7, for a downlink communication (e.g., a PDSCH communication), the TDRA parameters may include, for example, a K₀ value, an S value, and an L value. The K₀ value may represent a timing offset (e.g., in number of slots) between a slot containing the scheduling DCI (carrying a grant that schedules the PDSCH communication) and a slot containing the scheduled PDSCH communication (scheduled via the scheduling DCI). For example, as shown in FIG. 7, and by reference number 712, the UE 220 may receive DCI scheduling a PDSCH in a PDCCH monitoring occasion of slot number 0, and a value of the K₀ parameter may indicate the slot in which the UE 220 can expect to receive the PDSCH transmission scheduled via the DCI. For example, as shown by reference number 714, the UE 220 may expect to receive the PDSCH transmission in slot number 3 based on receiving the scheduling DCI in slot number 0 with the K₀ parameter indicating a timing offset of three slots. The S′ value may represent a starting symbol for the PDSCH transmission in the indicated slot. The L value may represent a length (e.g., a number of consecutive symbols) of the PDSCH transmission (e.g., in the indicated slot). In some examples, the S′ value and the L value may collectively be referred to as a start and length indicator value (SLIV). In some examples, the same row index value may correspond to a different set of TDRA parameters depending on a Type A DMRS position (e.g., a symbol within a resource block that contains the DMRS) and/or a PDSCH mapping type (e.g., indicating a starting symbol of the DMRS, a length of the DMRS, and/or whether slot-based scheduling or mini-slot-based scheduling is used).

Furthermore, in some examples, a K₁ parameter may be used to indicate a timing offset between the PDSCH transmission scheduled via the DCI and a slot in which the UE 220 is to transmit a PUCCH transmission that carries feedback information (e.g., ACK/NACK feedback for the PDSCH transmission), such as a HARQ ACK codebook transmission. For example, as shown by reference number 716, the UE 220 may be expected to receive a PDSCH transmission in slot number 3 based on the value of the K₀ parameter, and may transmit a PUCCH transmission that carries a HARQ ACK codebook for the PDSCH transmission in slot number 8 based on the K₁ parameter indicating a timing offset of five slots from the slot in which the PDSCH transmission is scheduled (e.g., slot number 3 in the illustrated example). In examples where a PDCCH transmission contains a multi-PDSCH grant, the K₁ parameter may be counted from the slot in which the last granted PDSCH transmission is scheduled. If the numerology of a downlink carrier and an uplink carrier are different (e.g., if an SCS of a PDSCH carrier and a PUCCH carrier are different), then the K₁ parameter may be counted with respect to the numerology of the uplink carrier. In such examples, the reference time interval (e.g., from which the K₁ parameter may be counted) may be the last uplink slot that overlaps with the downlink slot in which the PDSCH transmission (or PDCCH transmission) carrying the information scheduling the feedback transmission is received.

Accordingly, various timing offsets may be used in a wireless network to indicate a timing offset between a PDCCH transmission, a PDSCH transmission, a PUCCH, and/or a PUSCH transmission. For example, as described above, a K₀ parameter may indicate a timing offset (or slot offset) between a slot in which a PDCCH transmission is received and a slot in which a PDSCH transmission granted by the PDCCH transmission is scheduled, a K₁ parameter may indicate a timing offset between the slot in which the PDSCH transmission is scheduled and a slot in which a UE is to transmit ACK/NACK feedback for the PDSCH transmission, and/or a K₂ parameter may indicate a timing offset between a slot in which a PDCCH transmission is received and a slot in which a PUSCH transmission granted by the PDCCH transmission is scheduled. In general, the K₀, K₁, and/or K₂ parameters may be determined based on a TDRA field in the scheduling DCI. For example, the TDRA field may have a value that indicates a row index in an RRC-configured TDRA table, and the indicated row index may include a value for the K₀, K₁, and/or K₂ parameter (e.g., depending on whether the DCI schedules a PDSCH and/or a PUSCH). However, in some cases, the UE 220 may receive a PDCCH transmission that schedules a PDSCH transmission and/or a PUSCH transmission before receiving an RRC configuration. In such examples, the UE 220 may determine the value(s) of the K₀, K₁, and/or K₂ parameters from a default set of values indicated in a default TDRA table. In some examples, when a DCI format other than DCI format 1_0 schedules a PDSCH transmission or a semi-persistent scheduling (SPS) release, the K₁ parameter may be determined by a PDSCH-to-HARQ feedback timing indicator field in the scheduling DCI, which may map to a value for the K₁ parameter that is provided by a configured parameter (e.g., dl-DataToUL-ACK, or dl-DataToUL-ACKForDCIFormat1_2 for DCI format 1_2) that can have a value in a range from zero to fifteen, among other examples. Furthermore, in the PUSCH default TDRA table, the K₂ parameter may have a value of j, j+1, j+2, or j+3, where j is one for a subcarrier spacing of 15 kilohertz (kHz), one for a subcarrier spacing of 30 kHz, two for a subcarrier spacing of 60 kHz, or three for a subcarrier spacing of 120 KHz.

In some examples, a network entity may transmit one or more repetitions of a communication to improve coverage and/or reliability of the communication. For example, a UE may transmit repetitions of an uplink control channel communication (e.g., a PUCCH communication). The uplink control channel communication may indicate feedback information (e.g., HARQ feedback information), and/or a scheduling request, among other examples. A repetition factor can be indicated for a UE, which indicates a number of times that the UE should repeat transmission of the uplink control channel communication. The transmission of repetitions of the uplink control channel communication may improve robustness of the uplink control channel communication, which can experience poor performance in certain situations, such as when the UE is located at a cell edge or when uplink transmit power is limited.

The UE may determine one or more time intervals during which respective repetitions of an uplink control channel communication are to be transmitted. For example, the UE may determine the one or more time intervals by counting available time intervals from a reference time interval. For example, if a time interval is “counted” by the UE, then the UE may transmit a repetition of the control channel communication during the time interval. The reference time interval may be indicated by a slot offset in DCI (e.g., that triggers or schedules the uplink control channel communication), such as the K₁ value. For example, as shown in FIG. 7, the reference time interval may be the slot 8 indicated by reference number 716. As another example, the reference time interval may be indicated by configuration information (e.g., for periodic or semi-persistent uplink control channel communications) that indicate the periodicity and slot offset. A time interval (e.g., an uplink time interval and/or a flexible time interval) may be counted by the UE if the uplink channel resource configured during the time interval does not overlap in the time domain with synchronization signal block (SSB) resources configured during the time interval and if the uplink channel resource configured during the time interval has enough consecutive uplink or flexible symbols for the uplink channel communication (e.g., as indicated by a nrofsymbols parameter indicated for the uplink channel communication).

For example, the UE may determine time intervals

$$( e . g . , {N}_{PUCCH}^{repeat} slots )$$

for a PUCCH transmission starting from a slot (e.g., the reference time interval) indicated to the UE via the K₁ value (e.g., for HARQ-acknowledgement reporting), or a slot (e.g., the reference time interval) indicated for scheduling request reporting or CSI reporting. The UE may determine (e.g., count) time intervals

$$( e . g . , {N}_{PUCCH}^{repeat} slots )$$

having an uplink symbol (or a flexible symbol that is not an SSB symbol provided by a startingSymbolIndex IE) as a first symbol and having a number of consecutive symbols (e.g., uplink symbols or flexible symbols that are not SSB symbols) starting from the first symbol equal to or larger than a number of symbols provided by the nrofsymbols parameter. For periodic or semi-persistent CSI reporting communicated via PUCCH communications, the reference time interval may be indicated by a periodicity (e.g., T_{CSI}) and slot offset (e.g., T_{offset}) configured via an RRC configuration (e.g., configured by the higher layer parameter reportSlotConfig). For scheduling request reporting communicated via PUCCH communications, the reference time interval may be indicated by a periodicity (e.g., SR_{PERIODICITY}) and a slot offset (e.g., SR_{OFFSET}) configured for scheduling request reporting (e.g., configured by the higher layer parameter periodicityAndOffset for a PUCCH transmission conveying a scheduling request).

The introduction of SBFD configurations may introduce ambiguity as to how network entities (e.g., UEs and/or network nodes) are to count and/or identify valid time intervals for repetitions of uplink channel communications. For example, as described above, a network entity may be configured with or without restrictions as to time interval types during which repetitions of uplink channel communications can be transmitted. How the network entities are to count time intervals for repetitions of uplink channel communications and/or what constitutes available time intervals for the purpose of counting is not defined for the different configurations. Further, in some examples, SBFD time intervals may include both SBFD symbols and non-SBFD symbols. In such examples, the network entities may not have a unified approach as to how and/or if such SBFD time intervals are to be counted for the purpose of determining time intervals during which repetitions of uplink channel communications are to be transmitted. Additionally, repetitions of uplink channel communications may be scheduled or configured to occur on a mini-slot (sometime referred to as a sub-slot) basis or inter-slot basis. In such examples, the network entities may not have a unified approach as to how and/or if SBFD time intervals are to be counted for the purpose of determining time intervals during which repetitions of uplink channel communications are to be transmitted (e.g., if the SBFD time intervals include both SBFD symbols and non-SBFD symbols). As a result, the network entities may not be synchronized as to which time intervals are to be used for transmissions of repetitions of a given uplink channel communication. This may result in degraded performance, missed repetitions, and/or consumption of network resources associated with the transmission of the given uplink channel communication.

As indicated above, FIG. 7 is provided as an example. Other examples may differ from what is described with regard to FIG. 7.

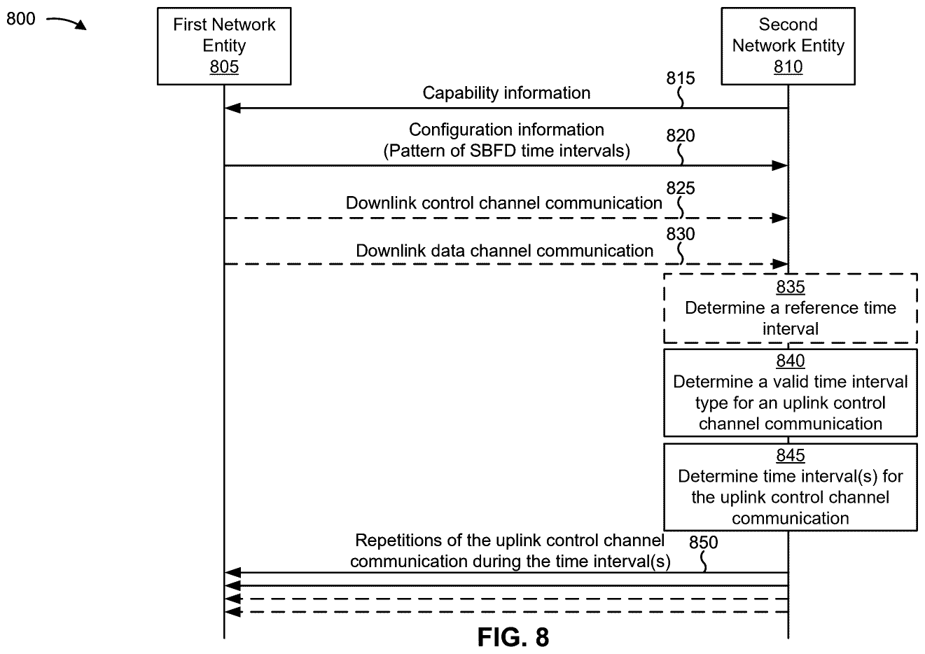

FIG. 8 is a diagram of an example 800 associated with uplink control channel repetitions for a full-duplex system, in accordance with the present disclosure. As shown in FIG. 8, a first network entity 805 (e.g., the network entity 102, the network entity 104, the network entity 106, the network node 210, a base station, a CU, a DU, and/or an RU) may communicate with a second network entity 810 (e.g., the network entity 102, the network entity 104, the network entity 106, and/or the UE 220). In some aspects, the first network entity 805 and the second network entity 810 may be part of a wireless network (e.g., the wireless communication network 200 or the environment 100).

Some aspects are described herein using an uplink control channel communication as an example. However, the aspects, techniques, processes, and/or methods described herein are not limited to uplink control channel communications. The aspects, techniques, processes, and/or methods described herein may be similarly applied to other types of control channel communications, such as downlink control channel communications (e.g., PDCCH communications), sidelink control channel communications (e.g., physical sidelink control channel (PSCCH) communications), and/or other types of control channel communications.

As used herein, the first network entity 805 “outputting” or “transmitting” a communication to the second network entity 810 may refer to a direct transmission (for example, from the first network entity 805 to the second network entity 810) or an indirect transmission via one or more other network nodes or devices, such as one or more TRPs or access nodes. For example, if the first network entity 805 is a DU or an access node controller, an indirect transmission to the second network entity 810 may include the first network entity 805 outputting or transmitting a communication to an RU (e.g., an access node or a TRP) and the RU transmitting the communication to the second network entity 810, or may include causing the RU to transmit the communication (e.g., triggering transmission of a physical layer reference signal). Similarly, the second network entity 810 “transmitting” a communication to the first network entity 805 may refer to a direct transmission (for example, from the second network entity 810 to the first network entity 805) or an indirect transmission via one or more other network nodes or devices, such as one or more TRPs or access nodes. For example, if the first network entity 805 is a DU or an access node controller, an indirect transmission to the first network entity 805 may include the second network entity 810 transmitting a communication to an RU (e.g., a TRP or an access node) and the RU transmitting the communication to the first network entity 805. Similarly, the first network entity 805 “obtaining” or “receiving” a communication may refer to receiving a transmission carrying the communication directly (for example, from the second network entity 810 to the first network entity 805) or receiving the communication (or information derived from reception of the communication) via one or more other network nodes or devices, such as one or more TRPs or access nodes.

In some aspects, as shown by reference number 815, the second network entity 810 may optionally transmit, and the first network entity 805 may receive, capability information. The capability information may be included in a capability report. The second network entity 810 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a PSCCH, and/or a physical sidelink shared channel (PSSCH)), among other examples. The capability information may indicate one or more parameters associated with respective capabilities of the second network entity 810. The one or more parameters may be indicated via respective information elements (IEs) included in a capability report.

The capability information may indicate whether the second network entity 810 supports a feature and/or one or more parameters related to the feature. For example, the capability information may indicate a capability and/or parameter for supporting full-duplex communication (e.g., SBFD communication). In some aspects, the capability information may indicate a capability and/or parameter for supporting one or more types of SBFD configurations. For example, the capability information may indicate whether the second network entity 810 supports an SBFD configuration that configures a restriction for types of time intervals (e.g., where transmissions/receptions are restricted to SBFD symbols only or non-SBFD symbols only) and/or an SBFD configuration that configures no restrictions (e.g., where transmissions/receptions can be in SBFD symbols and non-SBFD symbols). In some examples, the capability information may indicate a capability and/or parameter for supporting repetitions of control channel communications (e.g., uplink control channel communications). One or more operations described herein may be based on capability information. For example, the second network entity 810 may perform a communication in accordance with the capability information, or may receive configuration information that is in accordance with the capability information.

The first network entity 805 may determine configuration information based on, using, or otherwise associated with the capability information. In other examples, the first network entity 805 may determine the configuration information without, or independently of, the capability information. For example, the first network entity 805 may determine that the second network entity 810 supports repetitions of uplink control channel communications in an SBFD system as described herein based on a type, category, or other classification of the second network entity 810.

As shown by reference number 820, the first network entity 805 may transmit, and the second network entity 810 may receive, configuration information. In some aspects, the second network entity 810 may receive the configuration information via one or more of system information signaling (e.g., a master information block (MIB) and/or a system information block (SIB), among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the second network entity 810. For example, in some aspects, the configuration information may at least partially be defined by a wireless communication standard, such as the 3GPP. In such examples, the first network entity 805 may not explicitly indicate such configuration information to the second network entity 810. For example, the second network entity 810 may optionally obtain at least a portion of the configuration information from a configuration stored by the second network entity 810 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate a TDD pattern. For example, the configuration information may include a TDD configuration (e.g., indicated by a TDD-UL-DL-common IE). The TDD configuration may indicate a TDD pattern for uplink time intervals, downlink time intervals, and (optionally) flexible time intervals. For example, the TDD configuration may indicate a reference subcarrier spacing, a periodicity of the TDD pattern (e.g., via a dl-UL-TransmissionPeriodicity IE), a number of consecutive downlink time intervals at the beginning of each instance of the TDD pattern (e.g., via a nrofDownlinkSlots IE), a number of consecutive downlink symbols in the beginning of the slot following the last full downlink slot (e.g., via a nroff) ownlinkSymbols IE), a number of consecutive full uplink time intervals at the end of each instance of the TDD pattern (e.g., via a nroftplinkSlots IE), and/or a number of consecutive uplink symbols in the end of the slot preceding the first full uplink slot (e.g., via a nroftplinkSymbols IE), among other examples. Any time intervals (e.g., symbols and/or slots) that remain unallocated at the center of the TDD pattern (e.g., as indicated by the TDD configuration) may be configured as flexible time intervals that can be flexibly and/or dynamically allocated as either uplink or downlink time intervals.

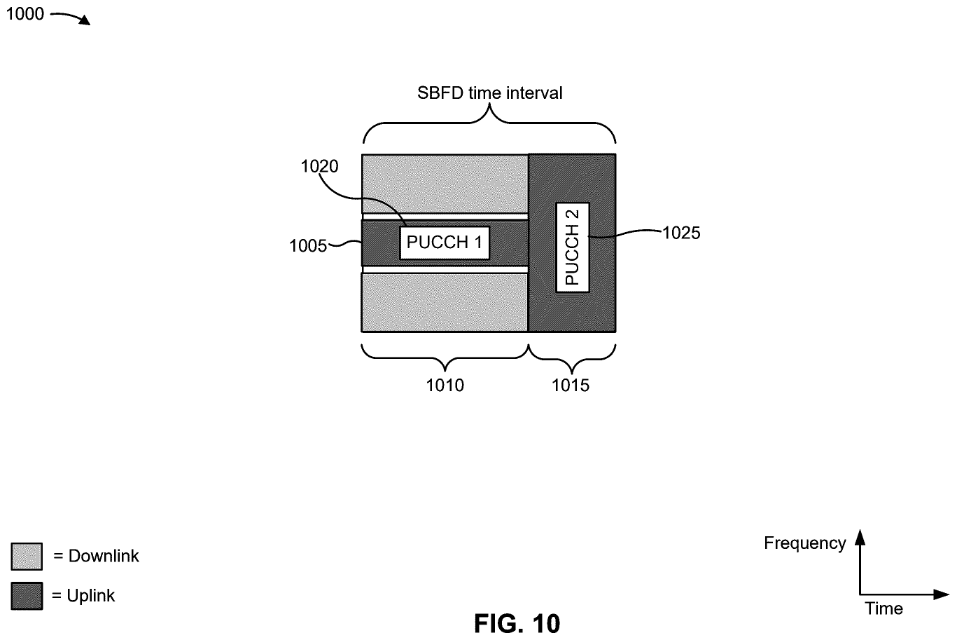

In some aspects, the configuration information may indicate a pattern of one or more SBFD time intervals and one or more non-SBFD time intervals. For example, the configuration information may indicate that one or more time intervals configured via the TDD configuration and/or TDD pattern are configured as SBFD time intervals. For example, the configuration information may indicate that one or more downlink time intervals and/or flexible time intervals indicated by the TDD configuration and/or TDD pattern are configured as SBFD time intervals for SBFD-aware network entities, such as the second network entity 810. In some examples, the configuration information may indicate downlink subband location(s) within the SBFD time interval(s) (e.g., in the time domain and/or the frequency domain), downlink subband location(s) within the SBFD time interval(s) (e.g., in the time domain and/or the frequency domain), and/or guard band location(s) within the SBFD time interval(s). For example, the configuration information may indicate that an SBFD time interval is fully configured as an SBFD time interval (e.g., includes only SBFD symbols). Alternatively, the configuration information may indicate that an SBFD time interval is configured to include both SBFD symbols and non-SBFD symbols (e.g., symbols configured as downlink symbols, uplink symbols, or flexible symbols). The configuration information may indicate time domain location(s) of the SBFD symbols and non-SBFD symbols within the SBFD time interval. An example of an SBFD time interval that includes both SBFD symbols and non-SBFD symbols is depicted and described in more detail in connection with FIG. 10.

In some aspects, the configuration information may include an SBFD configuration. The SBFD configuration may indicate whether there are any transmission or reception restrictions for uplink communications. Network entities that support SBFD communication (such as the second network entity 810) may be configured with a configuration that indicates whether transmissions and/or receptions across SBFD time intervals and non-SBFD time intervals (e.g., across SBFD symbols and non-SBFD symbols in different slots) are to be associated with a restriction as to a type of time interval in which the transmissions and/or receptions can occur. The transmissions and/or receptions across SBFD time intervals and non-SBFD time intervals may include periodic communications and/or repetitions of a communication that occur in different time intervals. A first configuration (sometimes referred to as a “configuration 1” for SBFD) may indicate that the transmissions and/or receptions are restricted to SBFD time intervals only or non-SBFD time intervals only (e.g., only one type (e.g., SBFD or non-SBFD) of time interval is valid for the transmissions and/or receptions). A second configuration (sometimes referred to as a “configuration 2” for SBFD) may indicate that the transmissions and/or receptions can occur in SBFD time intervals and non-SBFD time intervals (e.g., no restriction as to the valid type of time interval). The configuration information may indicate that the second network entity 810 is configured with either the configuration 1 or the configuration 2 for SBFD communication.

In some aspects, the configuration information may include uplink channel resource configuration information. The uplink channel resource configuration information may include an uplink channel configuration (e.g., indicated by a PUCCH-Config IE or a PUCCH-ConfigCommon IE), an uplink channel resource set configuration (e.g., indicated by a PUCCH-ResourceSet IE), and/or an uplink channel resource configuration, among other examples. In some aspects, the uplink channel resource configuration information may indicate repetition information for uplink channel resources. For example, a number (e.g., a quantity) of repetitions for uplink channel communications may be configured for each PUCCH resource, or for each PUCCH format. For example, the configuration information may indicate that the second network entity 810 is to transmit a PUCCH over

$${N}_{PUCCH}^{repeat}$$

time intervals (e.g., slots) using a PUCCH resource. A value of

$${N}_{PUCCH}^{repeat}$$

may be indicated by a field in DCI, such as the pucch-RepetitionNrofSlots field if the PUCCH resource is indicated by a DCI format that includes the pucch-RepetitionNrofSlots field. Otherwise, a value of

$${N}_{PUCCH}^{repeat}$$

may be indicated by a higher layer parameter, such as the nrofSlots parameter.

In some aspects, the repetition information for uplink channel resources may indicate that a PUCCH repetition can be across slots, mini-slots, or another time interval. For example, when a PUCCH repetition is across slots, one repetition may be transmitted in a given slot. When a PUCCH repetition is across mini-slots, one repetition may be transmitted in a given mini-slot. For example, the configuration information may indicate a parameter for configuring mini-slots (or sub-slots), such as the subslotLengthForPUCCH parameter. If the configuration information indicates the parameter for configuring mini-slots (or sub-slots), then a time interval (e.g., a slot) for PUCCH transmission with repetitions over multiple

$${N}_{PUCCH}^{repeat}$$

time intervals (e.g., slots) may include a number of symbols indicated by the parameter for configuring mini-slots (or sub-slots), such as the subslotlengthForPUCCH parameter. In other words, the second network entity 810 may be configured to use the number of symbols indicated by the parameter for configuring mini-slots (or sub-slots) as the time interval for the repetitions of the uplink control channel communication.

In some aspects, the uplink channel resource configuration information may indicate a valid time interval type for repetitions communicated via uplink channel resource(s) configured by the uplink channel resource configuration information. For example, an uplink channel configuration (e.g., indicated by a PUCCH-Config IE or a PUCCH-ConfigCommon IE), an uplink channel resource set configuration (e.g., indicated by a PUCCH-ResourceSet IE), and/or an uplink channel resource configuration, among other examples, may indicate a valid time interval type (e.g., SBFD or non-SBFD) for repetitions communicated via uplink channel resource(s).

The second network entity 810 may configure itself based on the configuration information. For example, the second network entity 810 may be configured to perform one or more actions or operations described herein based on the configuration information.

In some aspects, as shown by reference number 825, the first network entity 805 may transmit, and the second network entity 810 may receive, a downlink control channel communication (e.g., a PDCCH communication). In some aspects, the downlink control channel communication may indicate scheduling information for a downlink channel communication (e.g., for a PDSCH communication). In other aspects, the downlink control channel communication may include a semi-persistent scheduling (SPS) release indication (e.g., and may not schedule a downlink channel communication, such as a PDSCH communication).

The downlink control channel communication may indicate DCI. The DCI may schedule a downlink communication. In some aspects, the DCI may indicate that an uplink channel communication (e.g., a PUCCH) is to be transmitted by the second network entity 810 (e.g., the DCI may trigger an aperiodic PUCCH communication). In such examples, the DCI may indicate a reference time interval for the uplink channel communication. For example, for DCI may indicate an offset (e.g., a K₁ value as described in more detail in connection with FIG. 7) that is indicative of the reference time interval. As an example, the offset may indicate a number of time intervals between a time interval in which the downlink channel communication (e.g., a PDSCH communication) is to be transmitted (e.g., as shown by reference number 830) and the reference time interval. As another example, the offset may indicate a number of time intervals between a time interval in which the downlink control channel communication (e.g., the PDCCH communication) is transmitted (e.g., as shown by reference number 825) and the reference time interval, such as for PDCCH communications including the SPS release indication. For example, the offset may be indicated by a feedback timing indicator field (e.g., a PDSCH-to-HARQ feedback timing indicator field) in the DCI. If the DCI does not include the feedback timing indicator field, then the offset may be indicated by a dl-DataToUL-ACK parameter indicated by the configuration information.

In some aspects, as shown by reference number 830, the first network entity 805 may transmit, and the second network entity 810 may receive, a downlink data channel communication (e.g., a PDSCH communication). For example, the downlink data channel communication may be scheduled by the downlink control channel communication received by the second network entity 810 as described in connection with reference number 825. In other aspects, a downlink channel communication may not be communicated in association with the uplink control channel communication described herein, such as for periodic or semi-persistent uplink control channel communications and/or when the downlink control channel communication includes an SPS release indication, among other examples.

In some aspects, as shown by reference number 835, the second network entity 810 may determine a reference time interval for an uplink control channel communication. For example, the second network entity 810 may determine the reference time interval based on a time interval in which the downlink data channel communication is received (e.g., as depicted and described in connection with reference number 830). Alternatively, the second network entity 810 may determine the reference time interval based on a time interval in which the downlink control channel communication is received (e.g., as depicted and described in connection with reference number 825). For example, the reference time interval may be indicated by the offset indicated by DCI included in the downlink control channel communication as described in more detail elsewhere herein.

In some aspects, the reference time interval may be a valid time interval for transmission of the uplink control channel communication. For example, the second network entity 810 may expect that the reference time interval may be a valid time interval for transmission of the uplink control channel communication. In other words, the second network entity 810 may expect that a first repetition (e.g., an initial transmission) of the uplink control channel communication is to occur during the reference time interval. In other aspects, the reference time interval may not be a valid time interval for transmission of the uplink control channel communication. For example, the reference time interval may be configured as a downlink time interval. As another example, the reference time interval may include one or more SSB symbols (e.g., during which the uplink control channel communication cannot be transmitted).

As shown by reference number 840, the second network entity 810 may determine a valid time interval type for the uplink control channel communication (e.g., for a PUCCH communication). As used herein, “valid” time interval type refers to a type of time interval in which repetitions of the uplink control channel communication can be transmitted. For example, the valid time interval type may be SBFD or non-SBFD (e.g., if the configuration 1 is configured for the second network entity 810, as described elsewhere herein). In other examples, the valid time interval type may be both SBFD or non-SBFD (e.g., if the configuration 2 is configured for the second network entity 810, as described elsewhere herein).

In some aspects, the second network entity 810 may determine the valid time interval type based on the configuration information. For example, the uplink channel resource configuration information may indicate a valid time interval type for repetitions communicated via uplink channel resource(s) configured by the uplink channel resource configuration information. For example, an uplink channel configuration (e.g., indicated by a PUCCH-Config IE or a PUCCH-ConfigCommon IE), an uplink channel resource set configuration (e.g., indicated by a PUCCH-ResourceSet IE), and/or an uplink channel resource configuration, among other examples, may indicate a valid time interval type (e.g., SBFD or non-SBFD) for repetitions communicated via uplink channel resource(s). The second network entity 810 may determine the valid time interval type of an uplink control channel communication based on the valid time interval type configured for an uplink control channel resource that is to be used to transmit the uplink control channel communication (e.g., that is to be used to transmit an initial transmission of the uplink control channel communication).

In some aspects, the uplink channel resource configuration information may indicate a slot offset and/or periodicity for an uplink control channel resource (e.g., a PUCCH resource). The slot offset and/or periodicity may indicate a time interval during which a first instance of the uplink control channel resource is to occur. The second network entity 810 may determine the valid time interval type based on the time interval type of the time interval during which a first instance of the uplink control channel resource is to occur (e.g., as indicated by the slot offset and/or periodicity configured by the uplink channel resource configuration information). In such examples, the second network entity 810 may determine the valid time interval type based on the time interval type of the time interval indicated by the slot offset and/or periodicity configured by the uplink channel resource configuration information in a similar manner as using the time interval type of the reference time interval, as described in more detail elsewhere herein.

For example, the second network entity 810 may determine the valid time interval type based on a time interval type of the reference time interval. In some aspects, if the SBFD configuration indicates that the reference time interval is an SBFD time interval, then the valid time interval may be SBFD time intervals in some cases. For example, if the TDD configuration indicates that the reference time interval is a downlink time interval and the SBFD configuration indicates that the reference time interval is an SBFD time interval, then the valid time interval type may be SBFD. As another example, if the TDD configuration indicates that the reference time interval is a flexible time interval and the SBFD configuration indicates that the reference time interval is an SBFD time interval, then the valid time interval type may be SBFD. Alternatively, if the TDD configuration indicates that the reference time interval is a flexible time interval and the SBFD configuration indicates that the reference time interval is an SBFD time interval, then the valid time interval type may be non-SBFD (e.g., to ensure backward compatibility with network entities that are non-SBFD aware).

In some aspects, if the SBFD configuration indicates that the reference time interval is a non-SBFD time interval (e.g., a downlink time interval, an uplink time interval, a flexible time interval, or a time interval configured for half-duplex communication), then the valid time interval may be non-SBFD time intervals in some cases. For example, if the TDD configuration indicates that the reference time interval is an uplink time interval or a flexible time interval and the SBFD configuration indicates that the reference time interval is a non-SBFD time interval, then the valid time interval type may be non-SBFD. As another example, if the TDD configuration indicates that the reference time interval is a downlink time interval and the SBFD configuration indicates that the reference time interval is a non-SBFD time interval, then the valid time interval type may be non-SBFD. Alternatively, the second network entity 810 may not expect that the reference time interval to be a non-SBFD downlink time interval. For example, the second network entity 810 may consider the reference time interval being a non-SBFD downlink time interval as an error case. The first network entity 805 may refrain from (e.g., may avoid or may not) indicating that the reference time interval is a non-SBFD downlink time interval.

In some aspects, the reference time interval may include both SBFD symbols and non-SBFD symbols. In such examples, the valid time interval type may be indicated by a type of symbol in which the uplink control channel resource is configured (e.g., within the reference time interval). For example, if the uplink control channel resource is configured in non-SBFD symbols within the reference time interval, then the valid time interval type may be non-SBFD. If the uplink control channel resource is configured in SBFD symbols within the reference time interval, then the valid time interval type may be SBFD. As another example, the valid time interval type may be indicated by a type of symbol of a first (e.g., in time) symbol configured for the uplink control channel resource. For example, if the first (e.g., in time) symbol configured for the uplink control channel resource is a non-SBFD symbol (e.g., a non-SBFD uplink symbol), then the valid time interval type may be non-SBFD. If the first (e.g., in time) symbol configured for the uplink control channel resource is an SBFD symbol, then the valid time interval type may be SBFD.

In some aspects, if the reference time interval may include both SBFD symbols and non-SBFD symbols, then the second network entity 810 may determine that the valid time interval type is non-SBFD. Alternatively, if the reference time interval may include both SBFD symbols and non-SBFD symbols, then the second network entity 810 may determine that the valid time interval type is SBFD.

As shown by reference number 845, the second network entity 810 may determine one or more time intervals for the uplink control channel communication. For example, the second network entity 810 may determine time intervals during which respective repetitions of the uplink control channel communication are to be transmitted. For example, the second network entity 810 may count time intervals (e.g., starting at the reference time interval) for repetitions of the uplink control channel communication. If a time interval is counted, then the network entity 810 may transmit a repetition of the uplink control channel communication during the time interval (e.g., during an uplink control channel resource configured to occur during the time interval). In some aspects, a first time interval to be counted may be the reference time interval. In other aspects, the reference time interval may not be counted. A number of time intervals counted by the second network entity 810 may be based on the number of repetitions to be transmitted by the second network entity 810. For example, if the configuration information indicates that the second network entity 810 is to transmit M repetitions, then the second network entity 810 may count M time intervals.

In some aspects, the second network entity 810 may be configured with the configuration 1 for SBFD (e.g., that configures a restriction as to the types of time intervals that can be used to transmit communication(s) over multiple time intervals). In such examples, if the valid time interval type is SBFD (e.g., as determined by the second network entity 810 as described in connection with reference number 840), then the second network entity 810 may count an SBFD time interval if: (1) uplink control channel resources (e.g., PUCCH resources) are configured within an uplink subband of one or more SBFD symbols within the SBFD time interval: (2) a starting symbol of the uplink control channel resources is an SBFD symbol and does not overlap in the time domain with an SSB symbol (e.g., is not an SSB symbol); and (3) a number of consecutive symbols, after the starting symbol, that are SBFD symbols and that do not overlap in the time domain with an SSB symbol is equal to or larger than the number of symbols configured for the uplink control channel communication (e.g., as indicated by the nrofsymbols IE). In such examples, the SBFD time interval may include only SBFD symbols or may include both SBFD symbols and non-SBFD symbols. In such examples, the second network entity 810 may not count non-SBFD time intervals.

As another example where the second network entity 810 may be configured with the configuration 1 for SBFD, if the valid time interval type is non-SBFD (e.g., as determined by the second network entity 810 as described in connection with reference number 840), then the second network entity 810 may count a non-SBFD time interval if: (1) a starting symbol of the uplink control channel resources is an uplink symbol or a flexible symbol that does not overlap in the time domain with an SSB symbol; and (2) a number of consecutive uplink symbols or flexible symbols after the starting symbol satisfies a threshold indicated by the number of symbols configured for the uplink control channel communication (e.g., as indicated by the nrofsymbols IE). In such examples, the non-SBFD time interval may include only non-SBFD symbols or may include both SBFD symbols and non-SBFD symbols. In such examples, the second network entity 810 may not count SBFD time intervals or downlink time intervals.

In some aspects, if a time interval is configured as an SBFD time interval by the SBFD configuration and a flexible time interval by the TDD configuration, then the second network entity 810 may consider the time interval to be a non-SBFD time interval for the purposes of counting (e.g., as described above). Alternatively, if a time interval is configured as an SBFD time interval by the SBFD configuration and a flexible time interval by the TDD configuration, then the second network entity 810 may consider the time interval to be an SBFD time interval for the purposes of counting (e.g., as described above).

In some aspects, the second network entity 810 may be configured with the configuration 2 for SBFD (e.g., that configures no restrictions as to the types of time intervals that can be used to transmit communication(s) over multiple time intervals). In such examples, the valid time interval types may include both SBFD and non-SBFD. If a time interval is a non-SBFD time interval, then the second network entity 810 may count the non-SBFD time interval if: (1) a starting symbol of the uplink control channel resources is an uplink symbol or a flexible symbol that does not overlap in the time domain with an SSB symbol; and (2) a quantity of consecutive uplink symbols or flexible symbols after the starting symbol satisfies a threshold indicated by the number of symbols configured for the uplink control channel communication (e.g., as indicated by the nrofsymbols IE). If the time interval is an SBFD time interval, then the second network entity 810 may count the SBFD time interval if: (1) a starting symbol of the uplink control channel resources is an SBFD symbol that does not overlap in the time domain with an SSB symbol: (2) a number of consecutive SBFD symbols after the starting symbol satisfies a threshold indicated by the number of symbols configured for the uplink control channel communication (e.g., as indicated by the nrofsymbols IE); and (3) the symbols of the uplink control channel resource are configured within usable uplink frequency domain resources (e.g., in an uplink subband) of the SBFD symbol(s). In such examples, the time interval counted may include both SBFD symbols and non-SBFD symbols. In some aspects, if the time interval includes an uplink control channel resource that spans both SBFD symbols and non-SBFD symbols, then the second network entity 810 may not count the time interval.

As shown by reference number 850, the second network entity 810 may transmit, and the first network entity 805 may receive, one or more repetitions of the uplink control channel communication (e.g., one or more PUCCH repetitions). The second network entity 810 may transmit the one or more repetitions during respective time intervals counted by the second network entity 810 as described in connection with reference number 845. The uplink control communication may include feedback information (e.g., HARQ-acknowledgement information), such as for the downlink data channel communication transmitted as described in connection with reference number 830 or the downlink control channel communication transmitted as described in connection with reference number 825. As another example, the uplink control channel communication may indicate one or more scheduling requests. As another example, the uplink control channel communication may indicate CSI.

As indicated above, FIG. 8 is provided as an example. Other examples may differ from what is described with regard to FIG. 8.

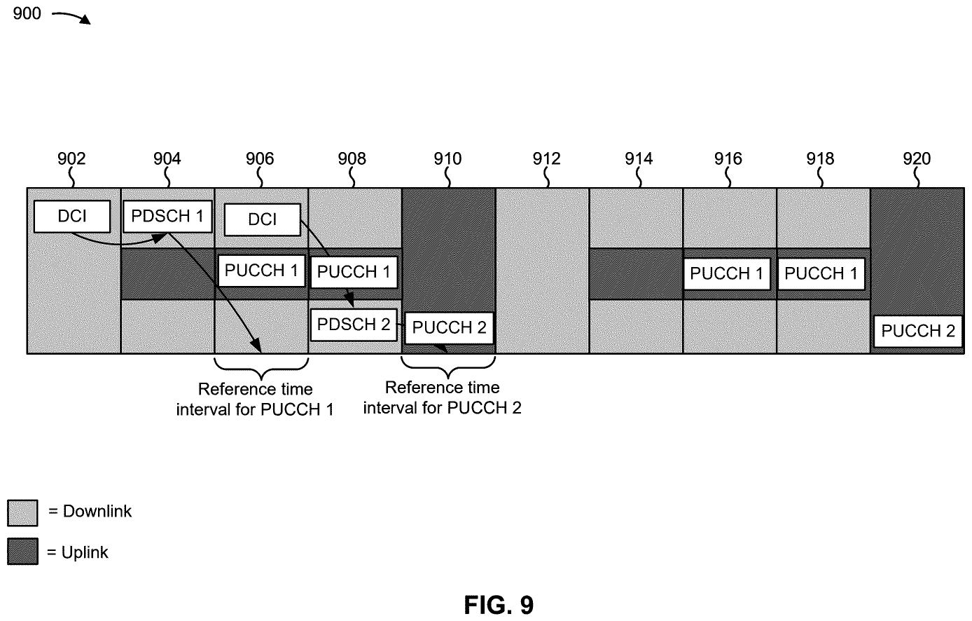

FIG. 9 is a diagram of an example 900 associated with uplink control channel repetitions for a full-duplex system, in accordance with the present disclosure. As shown in FIG. 9, a pattern of time intervals may be configured, such as for the second network entity 810. FIG. 9 depicts an example of aperiodic uplink control channel communications (e.g., that are triggered or indicated by DCI).

As shown in FIG. 9, a time interval 902, a time interval 904, a time interval 906, a time interval 908, a time interval 910, a time interval 912, a time interval 914, a time interval 916, a time interval 918, and a time interval 920 may be configured. The time interval 902 and the time interval 912 may be non-SBFD downlink time intervals. The time interval 904, the time interval 906, the time interval 908, the time interval 914, the time interval 916, and the time interval 918 may be SBFD time intervals. The time interval 910 and the time interval 920 may be non-SBFD uplink time intervals.

As shown in FIG. 9, DCI may be transmitted during the time interval 902. The DCI may schedule a downlink data channel communication (shown as PDSCH 1 in FIG. 9) to occur during the time interval 904. The DCI may include information (e.g., a slot offset) that indicates that the reference time interval for a first uplink control channel communication (e.g., shown is PUCCH 1 in FIG. 9) is the time interval 906. As shown in FIG. 9, the time interval 906 may be an SBFD time interval. Therefore, the valid time interval type of repetitions of the first uplink control channel communication may be SBFD. As shown in FIG. 9, a network entity (e.g., the second network entity 810) may count SBFD time intervals (e.g., in a similar manner as described in connection with reference number 845) to determine time intervals during which repetitions of the first uplink control channel communication are to be transmitted. For example, the network entity may count the time interval 908, the time interval 916, and the time interval 918. The network entity may not count the time interval 914 (e.g., even though the time interval 914 is an SBFD time interval). For example, an uplink control channel resource configured during the time interval 914 may at least partially overlap (e.g., in the time domain) with one or more SSB symbols, the uplink control channel resource may not be configured in an uplink subband, and/or the uplink control channel resource may be configured in both SBFD symbols and non-SBFD symbols, among other examples.

As shown in FIG. 9, another DCI may be transmitted during the time interval 906. The DCI may schedule a downlink data channel communication (shown as PDSCH 2 in FIG. 9) to occur during the time interval 908. The DCI may include information (e.g., a slot offset) that indicates that the reference time interval for a second uplink control channel communication (e.g., shown is PUCCH 2 in FIG. 9) is the time interval 910. As shown in FIG. 9, the time interval 910 may be a non-SBFD time interval. Therefore, the valid time interval type of repetitions of the second uplink control channel communication may be non-SBFD. As shown in FIG. 9, a network entity (e.g., the second network entity 810) may count SBFD time intervals (e.g., in a similar manner as described in connection with reference number 845) to determine time intervals during which repetitions of the second uplink control channel communication are to be transmitted. For example, the network entity may count the time interval 910 and the time interval 920 because these time intervals are configured as non-SBFD uplink time intervals.

As indicated above, FIG. 9 is provided as an example. Other examples may differ from what is described with regard to FIG. 9.

FIG. 10 is a diagram of an example 1000 associated with uplink control channel repetitions for a full-duplex system, in accordance with the present disclosure. As shown in FIG. 10, an SBFD time interval 1005 may be configured with one or more SBFD symbols 1010 and one or more non-SBFD symbols 1015. The SBFD time interval 1005 may be a reference time interval, as described in more detail elsewhere herein. In such examples, a network entity (e.g., the second network entity 810) may determine a valid time interval type for repetition of an uplink control channel communication based on a location or configuration of uplink channel resources (e.g., to be used to transmit the uplink control channel communication) within the SBFD time interval 1005.

For example, a first uplink control channel resource 1020 (e.g., shown in FIG. 10 as PUCCH 1) may be configured within the one or more SBFD symbols 1010. For example, as shown in FIG. 10, the first uplink control channel resource 1020 may be configured in an uplink subband of the one or more SBFD symbols 1010. In such examples, if the network entity is to transmit the uplink control channel communication using the first uplink control channel resource 1020, then the network entity may determine that the valid time interval type is SBFD (e.g., because the first uplink control channel resource 1020 (or a first symbol of the first uplink control channel resource 1020) is configured within an SBFD symbol (e.g., of the one or more SBFD symbols 1010).

As another example, a second uplink control channel resource 1025 (e.g., shown in FIG. 10 as PUCCH 2) may be configured within the one or more network non-SBFD symbols 1015. For example, as shown in FIG. 10, the second uplink control channel resource 1025 may be configured in uplink symbols of the one or more non-SBFD symbols 1015. In such examples, if the network entity is to transmit the uplink control channel communication using the second uplink control channel resource 1025, then the network entity may determine that the valid time interval type is non-SBFD (e.g., because the second uplink control channel resource 1025 (or a first symbol of the second uplink control channel resource 1025) is configured within a non-SBFD symbol (e.g., of the one or more non-SBFD symbols 1015).

As indicated above, FIG. 10 is provided as an example. Other examples may differ from what is described with regard to FIG. 10.

FIG. 11 is a diagram illustrating an example process 1100 performed, for example, at a network entity or an apparatus of a network entity, in accordance with the present disclosure. Example process 1100 is an example where the apparatus or the network entity (e.g., the second network entity 810, the network entity 102, and/or the UE 220) performs operations associated with uplink control channel repetitions for full-duplex system.

As shown in FIG. 11, in some aspects, process 1100 may include receiving first information indicating a pattern of one or more SBFD time intervals and one or more non-SBFD time intervals (block 1110). For example, the network entity (e.g., using reception component 1302 and/or communication manager 1306, depicted in FIG. 13) may receive first information indicating a pattern of one or more SBFD time intervals and one or more non-SBFD time intervals, as described above.

As further shown in FIG. 11, in some aspects, process 1100 may include receiving second information associated with multiple repetitions of an uplink control channel communication, wherein the second information is indicative of a valid time interval type for the multiple repetitions, and wherein the valid time interval type is either an SBFD type or a non-SBFD type (block 1120). For example, the network entity (e.g., using reception component 1302 and/or communication manager 1306, depicted in FIG. 13) may receive second information associated with multiple repetitions of an uplink control channel communication, wherein the second information is indicative of a valid time interval type for the multiple repetitions, and wherein the valid time interval type is either an SBFD type or a non-SBFD type, as described above.

As further shown in FIG. 11, in some aspects, process 1100 may include transmitting one or more repetitions, of the multiple repetitions, during one or more time intervals having the valid time interval type (block 1130). For example, the network entity (e.g., using transmission component 1304 and/or communication manager 1306, depicted in FIG. 13) may transmit one or more repetitions, of the multiple repetitions, during one or more time intervals having the valid time interval type, as described above.

Process 1100 may include additional aspects, such as any single aspect or any combination of aspects described below and/or in connection with one or more other processes described elsewhere herein.

In a first aspect, the second information indicates a reference time interval for the multiple repetitions, and the valid time interval type is indicated by a time interval type of the reference time interval.

In a second aspect, alone or in combination with the first aspect, process 1100 includes receiving third information indicating whether the one or more SBFD time intervals are downlink time intervals or flexible time intervals, and the time interval type of the reference time interval is indicated by the first information and the third information.

In a third aspect, alone or in combination with one or more of the first and second aspects, the valid time interval type is the SBFD type based on the first information indicating that the time interval type of the reference time interval is the SBFD type and the third information indicating that the time interval type of the reference time interval is a downlink type.

In a fourth aspect, alone or in combination with one or more of the first through third aspects, the valid time interval type is the SBFD type based on the first information indicating that the time interval type of the reference time interval is the SBFD type and the third information indicating that the time interval type of the reference time interval is a flexible type.

In a fifth aspect, alone or in combination with one or more of the first through fourth aspects, the valid time interval type is the non-SBFD type based on the first information indicating that the time interval type of the reference time interval is the SBFD type and the third information indicating that the time interval type of the reference time interval is a flexible type.

In a sixth aspect, alone or in combination with one or more of the first through fifth aspects, the valid time interval type is the non-SBFD type based on the first information indicating that the time interval type of the reference time interval is the non-SBFD type.

In a seventh aspect, alone or in combination with one or more of the first through sixth aspects, the first information indicates that the reference time interval includes one or more SBFD symbols and one or more non-SBFD symbols, wherein an uplink channel resource for the uplink control channel communication is configured in the reference time interval, and wherein the valid time interval type is based on one or more symbols, from the one or more SBFD symbols and one or more non-SBFD symbols, in which the uplink channel resource is configured.

In an eighth aspect, alone or in combination with one or more of the first through seventh aspects, the one or more symbols are a first symbol in a time domain.

In a ninth aspect, alone or in combination with one or more of the first through eighth aspects, the first information indicates that the reference time interval includes one or more SBFD symbols and one or more non-SBFD symbols, wherein the valid time interval type is based on a type of a first symbol in a time domain within the reference time interval.

In a tenth aspect, alone or in combination with one or more of the first through ninth aspects, the first information indicates that the reference time interval includes one or more SBFD symbols and one or more non-SBFD symbols, and the valid time interval type is the non-SBFD type based on the reference time interval including the one or more SBFD symbols and the one or more non-SBFD symbols.

In an eleventh aspect, alone or in combination with one or more of the first through tenth aspects, the first information indicates that the reference time interval includes one or more SBFD symbols and one or more non-SBFD symbols, and the valid time interval type is the SBFD type based on the reference time interval including the one or more SBFD symbols and the one or more non-SBFD symbols.

In a twelfth aspect, alone or in combination with one or more of the first through eleventh aspects, a transmission of a first repetition, of the multiple repetitions, is configured to occur during the reference time interval.

In a thirteenth aspect, alone or in combination with one or more of the first through twelfth aspects, the reference time interval is not a valid slot for transmission of the multiple repetitions.

In a fourteenth aspect, alone or in combination with one or more of the first through thirteenth aspects, process 1100 includes determining that an SBFD time interval is valid for transmission of a repetition, from the multiple repetitions, based on an uplink channel resource being configured within an uplink subband of the SBFD time interval, the uplink channel resource not overlapping in time with one or more synchronization signal block resources, and the uplink channel resource being configured in a quantity of SBFD symbols, within the SBFD time interval, that satisfies a threshold.

In a fifteenth aspect, alone or in combination with one or more of the first through fourteenth aspects, the first information indicates that a flexible time interval is configured as one of the one or more SBFD time intervals, wherein the valid time interval type is the non-SBFD type, and process 1100 includes determining that the flexible time interval is valid for transmission of a repetition from the multiple repetitions.

In a sixteenth aspect, alone or in combination with one or more of the first through fifteenth aspects, the first information indicates that a flexible time interval is configured as one of the one or more SBFD time intervals, wherein the valid time interval type is the SBFD type, and process 1100 includes determining that the flexible time interval is valid for transmission of a repetition from the multiple repetitions.

In a seventeenth aspect, alone or in combination with one or more of the first through sixteenth aspects, process 1100 includes receiving configuration information indicating that both the SBFD type or the non-SBFD type are available for transmission and reception, and determining that an SBFD time interval is valid for transmission of a repetition, from the multiple repetitions, based on an uplink channel resource being configured within an uplink subband of the SBFD time interval, the uplink channel resource not overlapping in time with one or more synchronization signal block resources, and the uplink channel resource being configured in a quantity of SBFD symbols, within the SBFD time interval, that satisfies a threshold.

In an eighteenth aspect, alone or in combination with one or more of the first through seventeenth aspects, the SBFD time interval is valid for transmission of the repetition based on the uplink channel resource being configured within only SBFD symbols in the SBFD time interval.

In a nineteenth aspects, alone or in combination with one or more of the first through eighteenth aspects, the second information includes configuration information for the uplink control channel communication, and the configuration information indicates the valid time interval type.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network entity or an apparatus of a network entity, in accordance with the present disclosure. Example process 1200 is an example where the apparatus or the network entity (e.g., the first network entity 805, the network entity 106, and/or a network node 210) performs operations associated with uplink control channel repetitions for full-duplex system.

As shown in FIG. 12, in some aspects, process 1200 may include transmitting first information indicating a pattern of one or more SBFD time intervals and one or more non-SBFD time intervals (block 1210). For example, the network entity (e.g., using transmission component 1404 and/or communication manager 1406, depicted in FIG. 14) may transmit first information indicating a pattern of one or more SBFD time intervals and one or more non-SBFD time intervals, as described above.

As further shown in FIG. 12, in some aspects, process 1200 may include transmitting second information associated with multiple repetitions of an uplink control channel communication, wherein the second information is indicative of a valid time interval type for the multiple repetitions, and wherein the valid time interval type is either an SBFD type or a non-SBFD type (block 1220). For example, the network entity (e.g., using transmission component 1404 and/or communication manager 1406, depicted in FIG. 14) may transmit second information associated with multiple repetitions of an uplink control channel communication, wherein the second information is indicative of a valid time interval type for the multiple repetitions, and wherein the valid time interval type is either an SBFD type or a non-SBFD type, as described above.

As further shown in FIG. 12, in some aspects, process 1200 may include receiving one or more repetitions, of the multiple repetitions, during one or more time intervals having the valid time interval type (block 1230). For example, the network entity (e.g., using reception component 1402 and/or communication manager 1406, depicted in FIG. 14) may receive one or more repetitions, of the multiple repetitions, during one or more time intervals having the valid time interval type, as described above.

Process 1200 may include additional aspects, such as any single aspect or any combination of aspects described below and/or in connection with one or more other processes described elsewhere herein.

In a first aspect, the second information indicates a reference time interval for the multiple repetitions, and the valid time interval type is indicated by a time interval type of the reference time interval.

In a second aspect, alone or in combination with the first aspect, process 1200 includes transmitting third information indicating whether the one or more SBFD time intervals are downlink time intervals or flexible time intervals, and the time interval type of the reference time interval is indicated by the first information and the third information.

In a third aspect, alone or in combination with one or more of the first and second aspects, the valid time interval type is the SBFD type based on the first information indicating that the time interval type of the reference time interval is the SBFD type and the third information indicating that the time interval type of the reference time interval is a downlink type.

In a fourth aspect, alone or in combination with one or more of the first through third aspects, the valid time interval type is the SBFD type based on the first information indicating that the time interval type of the reference time interval is the SBFD type and the third information indicating that the time interval type of the reference time interval is a flexible type.

In a fifth aspect, alone or in combination with one or more of the first through fourth aspects, the valid time interval type is the non-SBFD type based on the third information indicating that the time interval type of the reference time interval is a flexible type.

In a sixth aspect, alone or in combination with one or more of the first through fifth aspects, the valid time interval type is the non-SBFD type based on the first information indicating that the time interval type of the reference time interval is the non-SBFD type.

In a seventh aspect, alone or in combination with one or more of the first through sixth aspects, the first information indicates that the reference time interval includes one or more SBFD symbols and one or more non-SBFD symbols, wherein an uplink channel resource for the uplink control channel communication is configured in the reference time interval, and wherein the valid time interval type is based on one or more symbols, from the one or more SBFD symbols and one or more non-SBFD symbols, in which the uplink channel resource is configured.

In an eighth aspect, alone or in combination with one or more of the first through seventh aspects, the one or more symbols are a first symbol in a time domain.

In a ninth aspect, alone or in combination with one or more of the first through eighth aspects, the first information indicates that the reference time interval includes one or more SBFD symbols and one or more non-SBFD symbols, wherein the valid time interval type is based on a type of a first symbol in a time domain within the reference time interval.

In a tenth aspect, alone or in combination with one or more of the first through ninth aspects, the first information indicates that the reference time interval includes one or more SBFD symbols and one or more non-SBFD symbols, and the valid time interval type is the non-SBFD type based on the reference time interval including the one or more SBFD symbols and the one or more non-SBFD symbols.

In an eleventh aspect, alone or in combination with one or more of the first through tenth aspects, the first information indicates that the reference time interval includes one or more SBFD symbols and one or more non-SBFD symbols, and the valid time interval type is the SBFD type based on the reference time interval including the one or more SBFD symbols and the one or more non-SBFD symbols.

In a twelfth aspect, alone or in combination with one or more of the first through eleventh aspects, a transmission of a first repetition, of the multiple repetitions, is configured to occur during the reference time interval.

In a thirteenth aspect, alone or in combination with one or more of the first through twelfth aspects, the reference time interval is not a valid slot for transmission of the multiple repetitions.

In a fourteenth aspect, alone or in combination with one or more of the first through thirteenth aspects, the valid time interval type is the SBFD type, and process 1200 includes determining that an SBFD time interval is valid for transmission of a repetition, from the multiple repetitions, based on an uplink channel resource being configured within an uplink subband of the SBFD time interval, the uplink channel resource not overlapping in time with one or more synchronization signal block resources, and the uplink channel resource being configured in a quantity of SBFD symbols, within the SBFD time interval, that satisfies a threshold.

In a fifteenth aspect, alone or in combination with one or more of the first through fourteenth aspects, the first information indicates that a flexible time interval is configured as one of the one or more SBFD time intervals, wherein the valid time interval type is the non-SBFD type, and process 1200 includes determining that the flexible time interval is valid for transmission of a repetition from the multiple repetitions.

In a sixteenth aspect, alone or in combination with one or more of the first through fifteenth aspects, the first information indicates that a flexible time interval is configured as one of the one or more SBFD time intervals, wherein the valid time interval type is the SBFD type, and process 1200 includes determining that the flexible time interval is valid for transmission of a repetition from the multiple repetitions.

In a seventeenth aspect, alone or in combination with one or more of the first through sixteenth aspects, process 1200 includes transmitting configuration information indicating that both the SBFD type or the non-SBFD type are available for transmission and reception, and determining that an SBFD time interval is valid for transmission of a repetition, from the multiple repetitions, based on an uplink channel resource being configured within an uplink subband of the SBFD time interval, the uplink channel resource not overlapping in time with one or more synchronization signal block resources, and the uplink channel resource being configured in a quantity of SBFD symbols, within the SBFD time interval, that satisfies a threshold.

In an eighteenth aspect, alone or in combination with one or more of the first through seventeenth aspects, the SBFD time interval is valid for transmission of the repetition based on the uplink channel resource being configured within only SBFD symbols in the SBFD time interval.

In a nineteenth aspects, alone or in combination with one or more of the first through eighteenth aspects, the second information includes configuration information for the uplink control channel communication, and the configuration information indicates the valid time interval type.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a network entity, or a network entity may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 114, the communication manager 118, and/or the communication manager 250. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 110, the processing system 112, and/or the processing system 140).

In some aspects, the apparatus 1300 may be configured to perform one or more operations described herein in connection with FIGS. 8-10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components described in connection with FIGS. 1-3. Additionally, or alternatively, one or more components shown in FIG. 13 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components described above in connection with FIGS. 1-3, such as a radio, one or more RF chains, one or more transceivers, or one or more modems, each of which may in turn be coupled with one or more antennas of the network entity.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network entity described above in connection with FIG. 1, such as a radio, one or more RF chains, one or more transceivers, or one or more modems, each of which may in turn be coupled with one or more antennas described in connection with FIGS. 1-3. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive first information indicating a pattern of one or more SBFD time intervals and one or more non-SBFD time intervals. The reception component 1302 may receive second information associated with multiple repetitions of an uplink control channel communication, wherein the second information is indicative of a valid time interval type for the multiple repetitions, and wherein the valid time interval type is either an SBFD type or a non-SBFD type. The transmission component 1304 may transmit one or more repetitions, of the multiple repetitions, during one or more time intervals having the valid time interval type.

The reception component 1302 may receive third information indicating whether the one or more SBFD time intervals are downlink time intervals or flexible time intervals, and the time interval type of the reference time interval may be indicated by the first information and the third information.

The reception component 1302 may receive configuration information indicating that both the SBFD type or the non-SBFD type are available for transmission and reception.

The communication manager 1306 may determine that an SBFD time interval is valid for transmission of a repetition, from the multiple repetitions, based on: an uplink channel resource being configured within an uplink subband of the SBFD time interval: the uplink channel resource not overlapping in time with one or more synchronization signal block resources; and the uplink channel resource being configured in a quantity of SBFD symbols, within the SBFD time interval, that satisfies a threshold.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network entity, or a network entity may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 114, the communication manager 118, and/or the communication manager 255. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 110, the processing system 112, and/or the processing system 245).

In some aspects, the apparatus 1400 may be configured to perform one or more operations described herein in connection with FIGS. 8-10. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components described in connection with FIGS. 1-3. Additionally, or alternatively, one or more components shown in FIG. 14 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components described above in connection with FIGS. 1-3, such as a radio, one or more RF chains, one or more transceivers, or one or more modems, each of which may in turn be coupled with one or more antennas of the network entity.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network entity described above in connection with FIG. 1, such as a radio, one or more RF chains, one or more transceivers, or one or more modems, each of which may in turn be coupled with one or more antennas described in connection with FIGS. 1-3. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit first information indicating a pattern of one or more SBFD time intervals and one or more non-SBFD time intervals. The transmission component 1404 may transmit second information associated with multiple repetitions of an uplink control channel communication, wherein the second information is indicative of a valid time interval type for the multiple repetitions, and wherein the valid time interval type is either an SBFD type or a non-SBFD type. The reception component 1402 may receive one or more repetitions, of the multiple repetitions, during one or more time intervals having the valid time interval type.

The transmission component 1404 may transmit third information indicating whether the one or more SBFD time intervals are downlink time intervals or flexible time intervals, and the time interval type of the reference time interval is indicated by the first information and the third information.

The transmission component 1404 may transmit configuration information indicating that both the SBFD type or the non-SBFD type are available for transmission and reception.

The communication manager 1406 may determine that an SBFD time interval is valid for transmission of a repetition, from the multiple repetitions, based on: an uplink channel resource being configured within an uplink subband of the SBFD time interval: the uplink channel resource not overlapping in time with one or more synchronization signal block resources; and the uplink channel resource being configured in a quantity of SBFD symbols, within the SBFD time interval, that satisfies a threshold.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a network entity, comprising: receiving first information indicating a pattern of one or more subband full-duplex (SBFD) time intervals and one or more non-SBFD time intervals: receiving second information associated with multiple repetitions of an uplink control channel communication, wherein the second information is indicative of a valid time interval type for the multiple repetitions, and wherein the valid time interval type is either an SBFD type or a non-SBFD type; and transmitting one or more repetitions, of the multiple repetitions, during one or more time intervals having the valid time interval type.

Aspect 2: The method of Aspect 1, wherein the second information indicates a reference time interval for the multiple repetitions, and wherein the valid time interval type is indicated by a time interval type of the reference time interval.

Aspect 3: The method of Aspect 2, further comprising: receiving third information indicating whether the one or more SBFD time intervals are downlink time intervals or flexible time intervals, and wherein the time interval type of the reference time interval is indicated by the first information and the third information.

Aspect 4: The method of Aspect 3, wherein the valid time interval type is the SBFD type based on the first information indicating that the time interval type of the reference time interval is the SBFD type and the third information indicating that the time interval type of the reference time interval is a downlink type.

Aspect 5: The method of any of Aspects 3-4, wherein the valid time interval type is the SBFD type based on the first information indicating that the time interval type of the reference time interval is the SBFD type and the third information indicating that the time interval type of the reference time interval is a flexible type.

Aspect 6: The method of Aspect 3, wherein the valid time interval type is the non-SBFD type based on the first information indicating that the time interval type of the reference time interval is the SBFD type and the third information indicating that the time interval type of the reference time interval is a flexible type.

Aspect 7: The method of any of Aspects 3 and 6, wherein the valid time interval type is the non-SBFD type based on the first information indicating that the time interval type of the reference time interval is the non-SBFD type.

Aspect 8: The method of any of Aspects 3-7, wherein the first information indicates that the reference time interval includes one or more SBFD symbols and one or more non-SBFD symbols, wherein an uplink channel resource for the uplink control channel communication is configured in the reference time interval, and wherein the valid time interval type is based on one or more symbols, from the one or more SBFD symbols and one or more non-SBFD symbols, in which the uplink channel resource is configured.

Aspect 9: The method of Aspect 8, wherein the one or more symbols are a first symbol in a time domain.

Aspect 10: The method of any of Aspects 3-9, wherein the first information indicates that the reference time interval includes one or more SBFD symbols and one or more non-SBFD symbols, wherein the valid time interval type is based on a type of a first symbol in a time domain within the reference time interval.

Aspect 11: The method of Aspect 3, wherein the first information indicates that the reference time interval includes one or more SBFD symbols and one or more non-SBFD symbols, and wherein the valid time interval type is the non-SBFD type based on the reference time interval including the one or more SBFD symbols and the one or more non-SBFD symbols.

Aspect 12: The method of Aspect 3, wherein the first information indicates that the reference time interval includes one or more SBFD symbols and one or more non-SBFD symbols, and wherein the valid time interval type is the SBFD type based on the reference time interval including the one or more SBFD symbols and the one or more non-SBFD symbols.

Aspect 13: The method of any of Aspects 3-12, wherein a transmission of a first repetition, of the multiple repetitions, is configured to occur during the reference time interval.

Aspect 14: The method of any of Aspects 3-12, wherein the reference time interval is not a valid slot for transmission of the multiple repetitions.

Aspect 15: The method of any of Aspects 1-14, wherein the valid time interval type is the SBFD type, and wherein the processing system is configured to: determining that an SBFD time interval is valid for transmission of a repetition, from the multiple repetitions, based on: an uplink channel resource being configured within an uplink subband of the SBFD time interval: the uplink channel resource not overlapping in time with one or more synchronization signal block resources; and the uplink channel resource being configured in a quantity of SBFD symbols, within the SBFD time interval, that satisfies a threshold.

Aspect 16: The method of any of Aspects 1-15, wherein the first information indicates that a flexible time interval is configured as one of the one or more SBFD time intervals, wherein the valid time interval type is the non-SBFD type, and the method further comprising: determining that the flexible time interval is valid for transmission of a repetition from the multiple repetitions.

Aspect 17: The method of any of Aspects 1-16, wherein the first information indicates that a flexible time interval is configured as one of the one or more SBFD time intervals, wherein the valid time interval type is the SBFD type, and the method further comprising: determining that the flexible time interval is valid for transmission of a repetition from the multiple repetitions.

Aspect 18: The method of any of Aspects 1-17, further comprising: receiving configuration information indicating that both the SBFD type or the non-SBFD type are available for transmission and reception; and determining that an SBFD time interval is valid for transmission of a repetition, from the multiple repetitions, based on: an uplink channel resource being configured within an uplink subband of the SBFD time interval: the uplink channel resource not overlapping in time with one or more synchronization signal block resources; and the uplink channel resource being configured in a quantity of SBFD symbols, within the SBFD time interval, that satisfies a threshold.

Aspect 19: The method of Aspect 18, wherein the SBFD time interval is valid for transmission of the repetition based on the uplink channel resource being configured within only SBFD symbols in the SBFD time interval.

Aspect 20: A method of wireless communication performed by a network entity, comprising: transmitting first information indicating a pattern of one or more subband full-duplex (SBFD) time intervals and one or more non-SBFD time intervals: transmitting second information associated with multiple repetitions of an uplink control channel communication, wherein the second information is indicative of a valid time interval type for the multiple repetitions, and wherein the valid time interval type is either an SBFD type or a non-SBFD type; and receiving one or more repetitions, of the multiple repetitions, during one or more time intervals having the valid time interval type.

Aspect 21: The method of Aspect 20, wherein the second information indicates a reference time interval for the multiple repetitions, and wherein the valid time interval type is indicated by a time interval type of the reference time interval.

Aspect 22: The method of Aspect 21, further comprising: transmitting third information indicating whether the one or more SBFD time intervals are downlink time intervals or flexible time intervals, and wherein the time interval type of the reference time interval is indicated by the first information and the third information.

Aspect 23: The method of Aspect 22, wherein the valid time interval type is the SBFD type based on the first information indicating that the time interval type of the reference time interval is the SBFD type and the third information indicating that the time interval type of the reference time interval is a downlink type.

Aspect 24: The method of any of Aspects 22-23, wherein the valid time interval type is the SBFD type based on the first information indicating that the time interval type of the reference time interval is the SBFD type and the third information indicating that the time interval type of the reference time interval is a flexible type.

Aspect 25: The method of Aspect 22, wherein the valid time interval type is the non-SBFD type based on the third information indicating that the time interval type of the reference time interval is a flexible type.

Aspect 26: The method of any of Aspects 22 and 25, wherein the valid time interval type is the non-SBFD type based on the first information indicating that the time interval type of the reference time interval is the non-SBFD type.

Aspect 27: The method of any of Aspects 22-26, wherein the first information indicates that the reference time interval includes one or more SBFD symbols and one or more non-SBFD symbols, wherein an uplink channel resource for the uplink control channel communication is configured in the reference time interval, and wherein the valid time interval type is based on one or more symbols, from the one or more SBFD symbols and one or more non-SBFD symbols, in which the uplink channel resource is configured.

Aspect 28: The method of Aspect 27, wherein the one or more symbols are a first symbol in a time domain.

Aspect 29: The method of any of Aspects 22-28, wherein the first information indicates that the reference time interval includes one or more SBFD symbols and one or more non-SBFD symbols, wherein the valid time interval type is based on a type of a first symbol in a time domain within the reference time interval.

Aspect 30: The method of Aspect 22, wherein the first information indicates that the reference time interval includes one or more SBFD symbols and one or more non-SBFD symbols, and wherein the valid time interval type is the non-SBFD type based on the reference time interval including the one or more SBFD symbols and the one or more non-SBFD symbols.

Aspect 31: The method of Aspect 22, wherein the first information indicates that the reference time interval includes one or more SBFD symbols and one or more non-SBFD symbols, and wherein the valid time interval type is the SBFD type based on the reference time interval including the one or more SBFD symbols and the one or more non-SBFD symbols.

Aspect 32: The method of any of Aspects 22-31, wherein a transmission of a first repetition, of the multiple repetitions, is configured to occur during the reference time interval.

Aspect 33: The method of any of Aspects 22-31, wherein the reference time interval is not a valid slot for transmission of the multiple repetitions.

Aspect 34: The method of any of Aspects 20-33, wherein the valid time interval type is the SBFD type, and the method further comprising: determining that an SBFD time interval is valid for transmission of a repetition, from the multiple repetitions, based on: an uplink channel resource being configured within an uplink subband of the SBFD time interval: the uplink channel resource not overlapping in time with one or more synchronization signal block resources; and the uplink channel resource being configured in a quantity of SBFD symbols, within the SBFD time interval, that satisfies a threshold.

Aspect 35: The method of any of Aspects 20-34, wherein the first information indicates that a flexible time interval is configured as one of the one or more SBFD time intervals, wherein the valid time interval type is the non-SBFD type, and the method further comprising: determining that the flexible time interval is valid for transmission of a repetition from the multiple repetitions.

Aspect 36: The method of any of Aspects 20-35, wherein the first information indicates that a flexible time interval is configured as one of the one or more SBFD time intervals, wherein the valid time interval type is the SBFD type, and the method further comprising: determining that the flexible time interval is valid for transmission of a repetition from the multiple repetitions.

Aspect 37: The method of any of Aspects 20-36, further comprising: transmitting configuration information indicating that both the SBFD type or the non-SBFD type are available for transmission and reception; and determining that an SBFD time interval is valid for transmission of a repetition, from the multiple repetitions, based on: an uplink channel resource being configured within an uplink subband of the SBFD time interval: the uplink channel resource not overlapping in time with one or more synchronization signal block resources; and the uplink channel resource being configured in a quantity of SBFD symbols, within the SBFD time interval, that satisfies a threshold.

Aspect 38: The method of Aspect 37, wherein the SBFD time interval is valid for transmission of the repetition based on the uplink channel resource being configured within only SBFD symbols in the SBFD time interval.

Aspect 39: An apparatus for wireless communication at a device, the apparatus comprising one or more processors: one or more memories coupled with the one or more processors; and instructions stored in the one or more memories and executable by the one or more processors to cause the apparatus to perform the method of one or more of Aspects 1-38.

Aspect 40: An apparatus for wireless communication at a device, the apparatus comprising one or more memories and one or more processors coupled to the one or more memories, the one or more processors configured to cause the device to perform the method of one or more of Aspects 1-38.

Aspect 41: An apparatus for wireless communication, the apparatus comprising at least one means for performing the method of one or more of Aspects 1-38.

Aspect 42: A non-transitory computer-readable medium storing code for wireless communication, the code comprising instructions executable by one or more processors to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

Aspect 44: A device for wireless communication, the device comprising a processing system that includes one or more processors and one or more memories coupled with the one or more processors, the processing system configured to cause the device to perform the method of one or more of Aspects 1-38.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

Aspect 46: A device for wireless communication, the device comprising a processing system, the processing system configured to perform the method of one or more of Aspects 1-38.

Aspect 47: A non-transitory computer-readable medium having code stored thereon that, when executed by a device, causes the device to perform the method of one or more of Aspects 1-38.

The foregoing disclosure provides illustration and description but is neither exhaustive nor limiting of the scope of this disclosure. For example, various aspects and examples are disclosed herein, but this disclosure is not limited to the precise form in which such aspects and examples are described. Modifications and variations may be made in light of the above disclosure or may be acquired from practice of the aspects.

As used herein, the term “component” shall be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. Systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. As another example, “determining” can include resolving, selecting, obtaining, choosing, establishing, and/or other such similar actions.

Even though particular combinations of features are recited in the claims and/or disclosed in the specification, these combinations do not limit the scope of the disclosure. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As used herein, a phrase referring to “at least one of” a list of items refers to any combination of those items, including single members. As an example, “at least one of: a, b, or c” covers a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” may include one or more items referenced in connection with the article “the” and may be used interchangeably with “the one or more.” Furthermore, as used herein, the terms “set” and “group” may include one or more items and may be used interchangeably with “one or more.” Where only one item is intended, the phrase “only one” or similar language is used. Also, as used herein, the terms “has,” “have,” “having,” and similar terms are open-ended terms that do not limit an element that they modify (for example, an element “having” A may also have B). Further, the phrase “based on” means “based on or otherwise in association with” unless explicitly stated otherwise. Additionally, as used herein, the phrase “based on” shall not be construed as a reference to a closed set of information, one or more conditions, one or more factors, or the like. Also, as used herein, the term “or” is inclusive when used in a series and may be used interchangeably with “and/or,” unless explicitly stated otherwise (for example, if used in combination with “either” or “only one of”). Further, “one or more” may be equivalent to “at least one.”

Even though particular combinations of features are recited in the claims or disclosed in the specification, these combinations are not limiting of the disclosure of various aspects. Many of these features may be combined in ways not specifically recited in the claims or disclosed in the specification. The disclosure of various aspects includes each dependent claim in combination with every other claim in the claim set.

What is claimed is:

1. A network entity, comprising:
a processing system configured to:
receive first information indicating a pattern of one or more subband full-duplex (SBFD) time intervals and one or more non-SBFD time intervals;
receive second information associated with multiple repetitions of an uplink control channel communication, wherein the second information is indicative of a valid time interval type for the multiple repetitions, and wherein the valid time interval type is either an SBFD type or a non-SBFD type; and
transmit one or more repetitions, of the multiple repetitions, during one or more time intervals having the valid time interval type.

2. The network entity of claim 1, wherein the second information includes configuration information for the uplink control channel communication, and wherein the configuration information indicates the valid time interval type.

3. The network entity of claim 1, wherein the second information indicates a reference time interval for the multiple repetitions, and wherein the valid time interval type is indicated by a time interval type of the reference time interval.

4. The network entity of claim 3, wherein a transmission of a first repetition, of the multiple repetitions, is during the reference time interval.

5. The network entity of claim 4, wherein the processing system is configured to:
receive third information indicating whether the one or more SBFD time intervals are downlink time intervals or flexible time intervals, and wherein the time interval type of the reference time interval is indicated by the first information and the third information.

6. The network entity of claim 4, wherein the first information indicates that the reference time interval includes one or more SBFD symbols and one or more non-SBFD symbols, wherein an uplink channel resource for the uplink control channel communication is configured in the reference time interval, and wherein the valid time interval type is based on one or more symbols, from the one or more SBFD symbols and one or more non-SBFD symbols, in which the uplink channel resource is configured.

7. The network entity of claim 6, wherein the one or more symbols are a first symbol in a time domain.

8. The network entity of claim 4, wherein a transmission of a first repetition, of the multiple repetitions, is configured to occur during the reference time interval.

9. The network entity of claim 4, wherein the reference time interval is not a valid slot for transmission of the multiple repetitions.

10. The network entity of claim 1, wherein the valid time interval type is the SBFD type, and wherein the processing system is configured to:
determine that an SBFD time interval is valid for transmission of a repetition, from the multiple repetitions, based on: an uplink channel resource being configured within an uplink subband of the SBFD time interval: the uplink channel resource not overlapping in time with one or more synchronization signal block resources; and the uplink channel resource being configured in a quantity of SBFD symbols, within the SBFD time interval, that satisfies a threshold.

11. The network entity of claim 1, wherein the first information indicates that a flexible time interval is configured as one of the one or more SBFD time intervals, wherein the valid time interval type is the SBFD type, and wherein the processing system is configured to:
determine that the flexible time interval is valid for transmission of a repetition from the multiple repetitions.

12. The network entity of claim 1, wherein the processing system is configured to:
receive configuration information indicating that both the SBFD type or the non-SBFD type are available for transmission and reception; and
determine that an SBFD time interval is valid for transmission of a repetition, from the multiple repetitions, based on: an uplink channel resource being configured within an uplink subband of the SBFD time interval: the uplink channel resource not overlapping in time with one or more synchronization signal block resources; and the uplink channel resource being configured in a quantity of SBFD symbols, within the SBFD time interval, that satisfies a threshold.

13. The network entity of claim 12, wherein the SBFD time interval is valid for transmission of the repetition based on the uplink channel resource being configured within only SBFD symbols in the SBFD time interval.

14. The network entity of claim 1, wherein the processing system is configured to:
receive configuration information indicating a restriction for a time interval type that is available for transmission and reception; and
determine that an SBFD time interval is valid for transmission of a repetition, from the multiple repetitions, based on: an uplink control channel resource being configured within an uplink subband of the SBFD time interval: a starting symbol of the uplink control channel resource being an SBFD symbol and not overlapping in the time domain with one or more synchronization signal block symbols; and a number of consecutive symbols, after the starting symbol, that are SBFD symbols and that do not overlap in the time domain with the one or more synchronization signal block symbols being equal to or larger than the number of symbols configured for the uplink control channel communication.

15. The network entity of claim 1, wherein the processing system is configured to:
receive configuration information indicating a restriction for a time interval type that is available for transmission and reception; and
determine that a non-SBFD time interval is valid for transmission of a repetition, from the multiple repetitions, based on: a starting symbol of an uplink control channel resource being an uplink symbol or a flexible symbol that does not overlap in the time domain with one or more synchronization signal block symbols; and a number of consecutive uplink symbols or flexible symbols after the starting symbol satisfying a threshold indicated by the number of symbols configured for the uplink control channel communication.

16. A network entity, comprising:
a processing system configured to:
transmit first information indicating a pattern of one or more subband full-duplex (SBFD) time intervals and one or more non-SBFD time intervals;
transmit second information associated with multiple repetitions of an uplink control channel communication, wherein the second information is indicative of a valid time interval type for the multiple repetitions, and wherein the valid time interval type is either an SBFD type or a non-SBFD type; and
receive one or more repetitions, of the multiple repetitions, during one or more time intervals having the valid time interval type.

17. The network entity of claim 16, wherein the second information includes configuration information for the uplink control channel communication, and wherein the configuration information indicates the valid time interval type.

18. The network entity of claim 16, wherein the second information indicates a reference time interval for the multiple repetitions, and wherein the valid time interval type is indicated by a time interval type of the reference time interval.

19. The network entity of claim 18, wherein a transmission of a first repetition, of the multiple repetitions, is during the reference time interval.

20. A method of wireless communication performed by a network entity, comprising:
receiving first information indicating a pattern of one or more subband full-duplex (SBFD) time intervals and one or more non-SBFD time intervals;
receiving second information associated with multiple repetitions of an uplink control channel communication, wherein the second information is indicative of a valid time interval type for the multiple repetitions, and wherein the valid time interval type is either an SBFD type or a non-SBFD type; and
transmitting one or more repetitions, of the multiple repetitions, during one or more time intervals having the valid time interval type.
